(19) United States
(12) Patent Application Publication
(10) Pub. No.: US 2025/0110270 A1
(43) Pub. Date: Apr. 3, 2025

(54) OPTICAL CO-PACKAGING ON A GLASS SUBSTRATE WITH 3D DIE-STACKING

(71) Applicant: Intel Corporation, Santa Clara, CA (US)

(72) Inventors: Chia-Pin Chiu, Tempe, AZ (US); Kaveh Hosseini, Livermore, CA (US)

(73) Assignee: Intel Corporation, Santa Clara, CA (US)

(21) Appl. No.: 18/478,871

(22) Filed: Sep. 29, 2023

(51) Int. Cl. G02B 6/12

(52) U.S. Cl. CPC G02B 6/12002; G02B 6/12004

(57) ABSTRACT

The substrate of an integrated circuit component comprises a multi-layer die structure conductively coupled to the substrate. The multi-die layered structure includes a first primary integrated circuit die attached to the substrate and communicatively coupled to a first photonic integrated circuit (PIC) die, and a second primary integrated circuit die vertically spaced from the first primary integrated circuit die and communicatively coupled to a second PIC die. The integrated circuit component further includes a first intermediate waveguide optically coupling a first PIC waveguide of the first PIC die to a first substrate waveguide in the substrate, and a second intermediate waveguide optically coupling a second PIC waveguide of the second PIC die to a second substrate waveguide in the substrate. The integrated circuit component may further include a third intermediate waveguide optically coupling the first PIC die to the second PIC die.

### BACKGROUND

Optical fiber cables (or fiber optic cables) are capable of delivering information via optical signals over great distances at high speeds. For the information carried by optical signals to be processed by electronic integrated circuit components, the information needs to be transferred from the photonic domain to the electrical domain. In some existing approaches, this transfer can comprise an optical signal passing from an optical fiber to a waveguide in a photonic integrated circuit attached to the optical fiber. The optical signal is translated into an electronic signal and passed to a processing unit or other component. Thus, additional space in a substrate is used to accommodate a photonic integrated circuit for each integrated circuit component mounted on the substrate.

### BRIEF DESCRIPTION OF THE DRAWINGS

FIG. 1A is a cutaway perspective view of a portion of a first example integrated circuit component showing a bottom layer of a multi-die layered structure and a portion of a substrate.

FIG. 1B is a perspective view of the first example integrated circuit component including the multi-die layered structure and substrate shown in FIG. 1A and with the addition of a waveguide array in the substrate.

FIG. 1C is a cross-sectional view of the first example integrated circuit component of FIG. 1A with the addition of photonic waveguide bonds (PWBs).

FIG. 1D is a top plan view of the first example integrated circuit component of FIG. 1C with the waveguide arrays connected by the photonic waveguide bonds.

FIGS. 2A-2M are side views of the first example integrated circuit component, including interlocking layers of the multi-die layered structure, the substrate, and the photonic waveguide bonds of FIGS. 1A-1D at various stages of manufacture.

FIG. 3A is a top plan view of a second example integrated circuit component including a second example multi-die layered structure, a substrate, and two substrate waveguide arrays.

FIG. 3B is a cross-sectional view of the second example integrated circuit component of FIG. 3A with the addition of photonic waveguide bonds.

FIG. 4A is a top plan view of a third example integrated circuit component including a third example multi-die layered structure, a substrate, and two substrate waveguide arrays.

FIG. 4B is a cross-sectional view of the third example integrated circuit component of FIG. 4A with the addition of photonic waveguide bonds.

FIG. 5A is a top plan view of a fourth example integrated circuit component including a fourth example multi-die layered structure, a substrate, and two substrate waveguide arrays.

FIG. 5B is a cross-sectional view of the fourth example integrated circuit component of FIG. 5A with the addition of photonic waveguide bonds.

FIG. 6A is a top plan view of a fifth example integrated circuit component including a fifth example multi-die layered structure, a substrate, and a substrate waveguide array.

FIG. 6B is a cross-sectional view of the fifth example integrated circuit component of FIG. 6A with the addition of a first example optical coupler.

FIG. 6C is a front view of the first example optical coupler.

FIG. 7A is a top plan view of a sixth example integrated circuit component including a sixth example multi-die layered structure, a substrate, and a micro-lens array coupled to a substrate waveguide array.

FIG. 7B is a cross-sectional view of the sixth example integrated circuit component of FIG. 7A with the addition of a second example optical coupler.

FIG. 7C is a front view of the second example optical coupler.

FIG. 8 is an example method of forming the first example integrated circuit component comprising a substrate and a multi-die layered structure attached to the substrate.

FIG. 9 is a top view of a wafer and dies that may be included in any of the microelectronic assemblies or integrated circuit components disclosed herein.

FIG. 10 is a cross-sectional of an integrated circuit device that may be included in a microelectronic assembly or integrated circuit component, in accordance with any of the embodiments disclosed herein.

FIG. 11 is a cross-sectional side of an integrated circuit device assembly that may include any of the microelectronic assemblies or integrated circuit components disclosed herein.

FIG. 12 is a block diagram of an example electrical device that may include one or more of the microelectronic assemblies or integrated circuit components disclosed herein.

### DETAILED DESCRIPTION

Disclosed herein are integrated circuit component package technologies that provide for stacking or layering various types of integrated circuit (IC) dies related to computer systems, including corresponding photonic integrated circuit (PIC) dies that enable optical interconnection of processing units, memory, networking elements, storage elements, and other computer system components that are associated with computer processing functionalities and implemented in a primary integrated circuit die. In one or more examples, two or more PIC dies are communicatively coupled, respectively, to two or more primary IC dies in a multi-die layered structure (also referred to herein as a ‘multi-die layered structure’, ‘stack structure’, or ‘stack’). The multi-die layered structure is attached to a substrate that includes a recess extending partially through the substrate and that is sized to accommodate a portion of the stack, such as a PIC die in the first (bottom) layer of the stack and communicatively coupled with the first, (bottom) primary IC die in the stack. In other examples, a cutout extending through the substrate may be used to accommodate a portion of the stack.

A multi-die layered structure can include primary IC dies and corresponding PIC dies to which the primary IC dies are respectively coupled. Each primary IC die attached to a corresponding PIC die forms one interlocking layer in the multi-die layered structure. Electrical integrated circuits (EICs) may be used to interconnect and enable communication between PIC dies and respective IC dies. The EICs may be electrically coupled to the primary integrated circuit dies. The EICs may be attached to the PIC dies using, for example, a device-to-device (D2D) interconnection. An EIC may be implemented in various ways including, but not necessarily limited to, integration into a primary IC die, integration into a PIC die, or as a separate EIC die (or integrated with a chiplet) conductively coupled to a primary IC die and to a PIC die. PIC dies may be layered in the multi-layer die stack. Depending on the particular stack arrangement, a given PIC die in the stack may be attached (e.g., nonconductive bonding) to PIC dies in different interlocking layers above and below the given PIC die, to an adjacent (above or below) primary IC die of a different interlocking layer, and/or to an adjacent (above or below) EIC die of a different interlocking layer. In some examples, the IC dies, PIC dies, and EIC dies (if not integrated in an IC die or PIC die) are arranged in a stairstep configuration, with each layer of dies decreasing in width from the first (bottom) layer attached to the substrate to the last (top) layer.

Each primary IC die in a stack may be communicatively coupled to one or more other primary IC dies in the stack. In at least one example, a PIC die connected to a primary IC die in a multi-die layered structure is provisioned with a plurality of waveguides (also referred to herein as ‘PIC waveguide array” or “PIC waveguides”). The PIC waveguides of the PIC die are interconnected to other PIC waveguides in one or more other PIC dies in the stack by intermediate linking waveguides, such as photonic waveguide bonds (PWBs) or an optical coupler utilizing micro-lens arrays. In one or more examples, PWBs are freeform waveguides that can be used to align first ends of the PWBs with PIC waveguides in a PIC die and to align opposite ends of the PWBs with PIC waveguides of another PIC die in the multi-die layered structure or to waveguides in the substrate. The PWBs that interconnect a particular PIC die with one or more other PIC dies in a stack enable communication between the primary IC die communicatively coupled to the attached PIC die and the one or more other primary IC dies attached, respectively, to the one or more other PIC dies in the stack.

In one or more examples, for any given PIC die communicatively coupled to a primary IC die in a multi-die layered structure, at least one PIC waveguide in the PIC die may be communicatively coupled to a waveguide in in the substrate. The substrate can include a plurality of waveguides (referred to herein as “substrate waveguide array” or “substrate waveguides”). The substrate waveguide array enables communication from a primary IC die in the stack to other primary IC dies in a different tile in the same substrate with multi-die layering (“stacked”), in a different tile in the same substrate without multi-die layering (“unstacked”), in a different stacked or unstacked tile in a different package, etc. Thus, the substrate waveguides provisioned for a multi-die layered structure can enable communication between a computer system component (e.g., one of the primary IC dies in the stack) and other integrated circuit components (stacked or unstacked) in the same integrated circuit component package or in other integrated circuit component packages in the same device or other devices (e.g., via a network or other connection). The substrate waveguide array may be embedded in, formed in, attached to, or mounted on the substrate or otherwise accessible for connection to PIC dies in the stack. In one example, PIC waveguides provisioned in each PIC die enable interconnection by PWBs to substrate waveguides in the substrate. In one example, a PWB can be embodied as a wire waveguide having a first end that terminates at a PIC waveguide in a PIC die and an opposite end that terminates at a substrate waveguide in the substrate.

In another example, micro-lens arrays and an optical coupler in the form of a solid structure (e.g., glass, ceramic, etc.) with waveguides may be used to enable communication with optical signals between the PIC dies and substrate waveguides. Each PIC die may be provisioned with a micro-lens array. An optical coupler is provided with a corresponding micro-lens array for each PIC micro-lens array. Waveguides formed through the optical coupler carry the light waves to corresponding waveguides in the substrate waveguide array, and vice versa.

Integrated circuit stack components comprising layered integrated circuit components and corresponding PICs for optical interconnection of the integrated circuit components offer at least the following advantages. First, three-dimensional stacking minimizes the x-y directional footprint of a substrate on which the integrated circuit components are mounted. Second, stacking integrated circuit components reduces bump and pin counts for input/output (I/O) communication when the integrated circuit components are interconnected optically with another integrated circuit component, a glass substrate, and another package. Third, a glass substrate embedded with low loss optical waveguides and PWBs can provide excellent optical communication among stacked-dies and the glass substrate. PWBs are used to bridge the waveguide in the PIC and the waveguide in the glass substrate for easy assembly, especially in the three-dimensional integrated circuit component-stacked configuration. Fourth, a glass substrate can be made by a panel process resulting in lower costs, whereas an interposer is typically made by a more expensive wafer process. Fifth, the close Coefficient of Thermal Expansion (CTE) between Silicon (Si) die and a glass substrate can result in less substrate warpage, enabling a larger package to be used if needed. Sixth, Photonic Waveguide Bonding can aid the flexibility in design and routing of the package as free-form wire waveguides are used to connect multiple PIC dies in a multi-die stack with waveguides in a substrate that enable interconnection to other multi-die stacks, single-dies, and/or separate IC packages.

In the following description, specific details are set forth, but embodiments of the technologies described herein may be practiced without these specific details. Well-known circuits, structures, and techniques have not been shown in detail to avoid obscuring an understanding of this description. Phrases such as “an embodiment,” “various embodiments,” “some embodiments,” “at least one embodiment,” “one or more embodiments,” and the like may include features, structures, or characteristics, but not every embodiment necessarily includes the particular features, structures, or characteristics.

Some embodiments may have some, all, or none of the features described for other embodiments. “First,” “second,” “third,” and the like describe a common object and indicate different instances of like objects being referred to. Unless specifically indicated otherwise, such adjectives do not imply objects so described must be in a given sequence, either temporally or spatially, in ranking, or any other manner. “Connected” may indicate elements are in direct physical or electrical contact with each other and “coupled” may indicate elements co-operate, communicate, or interact with each other, but they may or may not be in direct physical or electrical contact. Furthermore, the terms “comprising,” “including,” “having,” and the like, as used with respect to embodiments of the present disclosure, are synonymous.

Terms modified by the word “substantially” include arrangements, orientations, spacings, or positions that vary slightly from the meaning of the unmodified term. For example, an edge or surface of a PIC die or IC die that is substantially flush or coplanar with another surface or a wall of a substrate recess or cutout includes an edge of a PIC that is within the placement tolerance of attaching an integrated circuit component to a substrate (e.g., 5-10 microns). A substantially planar surface can include some surface roughness. A surface or sidewall that is substantially perpendicular to a wafer or s substrate surface or a die surface (e.g., of an IC, PIC, EIC, etc.) includes surfaces or sidewalls that are within 15 degrees of being perpendicular to the wafer or substrate surface or die surface. A first die that is substantially parallel to a second die (e.g., wafer or substrate surface) includes first features that are within +/−five degrees of the second feature. Moreover, a stated value for a dimension, feature, or characteristic qualified by the term “about” includes values within +/−10% of the stated value. Similarly, a stated range of values for a dimension, feature, or characteristic includes values within 10% of the listed upper and lower values for the range.

Certain terminology may also be used herein for the purpose of reference only, and thus are not intended to be limiting. For example, terms such as “upper,” “lower,” “above,” “below,” “bottom,” and “top” refer to directions in the Figures to which reference is made. Terms such as “front,” “back,” “rear,” and “side” describe the orientation and/or location of portions of the integrated circuit component within a consistent but arbitrary frame of reference which is made clear by reference to the text and the associated Figures describing the component under discussion. Such terminology may include the words specifically mentioned above, derivatives thereof, and words of similar import.

As used herein, the term “integrated circuit component” refers to a packaged or unpackaged integrated circuit product that comprises at least one multi-die layered structure that includes two or more primary integrated circuit dies and is mounted on a component substrate. The packaged integrated circuit component may or may not be encapsulated in a casing material, such as metal, plastic, glass, or ceramic. An integrated circuit component comprising multiple integrated circuit dies can be referred to as a multi-chip package (MCP) or multi-chip module (MCM). In one example, a packaged integrated circuit component contains two or more processor units (XPUs) with corresponding electrical integrated circuits (EICs) and photonic integrated circuits (PICs) arranged in a multi-die layered structure that is mounted on a component substrate, and with an exterior surface of the component substrate comprising a solder ball grid array (BGA) for connecting to a socket. In one example of an unpackaged integrated circuit component, multiple monolithic integrated circuit dies are arranged in a stack formation with interconnects between each adjacent IC die, and with a bottom IC die comprising solder bumps attached to contacts on the die. The solder bumps allow the die to be directly attached to a printed circuit board. In this scenario, a waveguide array may be formed in a suitable material (e.g., glass block) and mounted on or near the printed circuit board to enable an optical connection to the PIC dies in the stack. One or more additional stacks of multiple monolithic integrated circuit dies may be similarly configured and attached to the printed circuit board. An integrated circuit component can comprise one or more of any computing system component described or referenced herein or any other computing system component, such as (but not necessarily limited to) a processor unit (e.g., system-on-a-chip (SoC), processor core, graphics processor unit (GPU), accelerator, chipset processor), I/O controller, memory, memory controller, or network interface controller.

An integrated circuit component with die-stacking (also referred to herein as “die-stacked component”) refers to a packaged or unpackaged integrated circuit product with die stacking. A packaged die-stacked component comprises one or more multi-die layered structures mounted on a component substrate. A packaged die-stacked component includes zero, one, or more single layer die structures mounted to the same substrate having at least one multi-die layered structure mounted to the substrate. The packaged die-stacked component may or may not be encapsulated in a casing material, such as metal, plastic, glass, or ceramic. A die-stacked component is an example of an MCP or MCM. In one example, a packaged die-stacked component includes at least one multi-die layered structure including two or more processor units (XPUs) with the multi-die layered structure mounted on a component substrate and an exterior surface of the component substrate comprising a solder ball grid array (BGA). In one example of an unpackaged die-stacked component, multiple monolithic integrated circuit dies are arranged in a stack formation with a lower surface of the multi-die layered structure comprising solder bumps attached to contacts on the die. The solder bumps allow the stacked dies to be directly attached to a printed circuit board. In this scenario, a waveguide array may be formed in a suitable material (e.g., glass block) and mounted on or near the printed circuit board to enable an optical connection to the PIC dies in the stack. One or more stacks of monolithic integrated circuit dies may be similarly configured and attached to the printed circuit board. The IC dies shown and referenced in the multi-die stacks herein can include dies fabricated with any functional circuit to achieve computing system components described or referenced herein, such as a processor unit (e.g., system-on-a-chip (SoC), processor core, graphics processor unit (GPU), accelerator, chipset processor), I/O controller, memory, or network interface controller. In some scenarios, the same (or same type of) integrated circuit component are used in one stack. In other examples, different (or different types of) integrated circuit components are used in one stack.

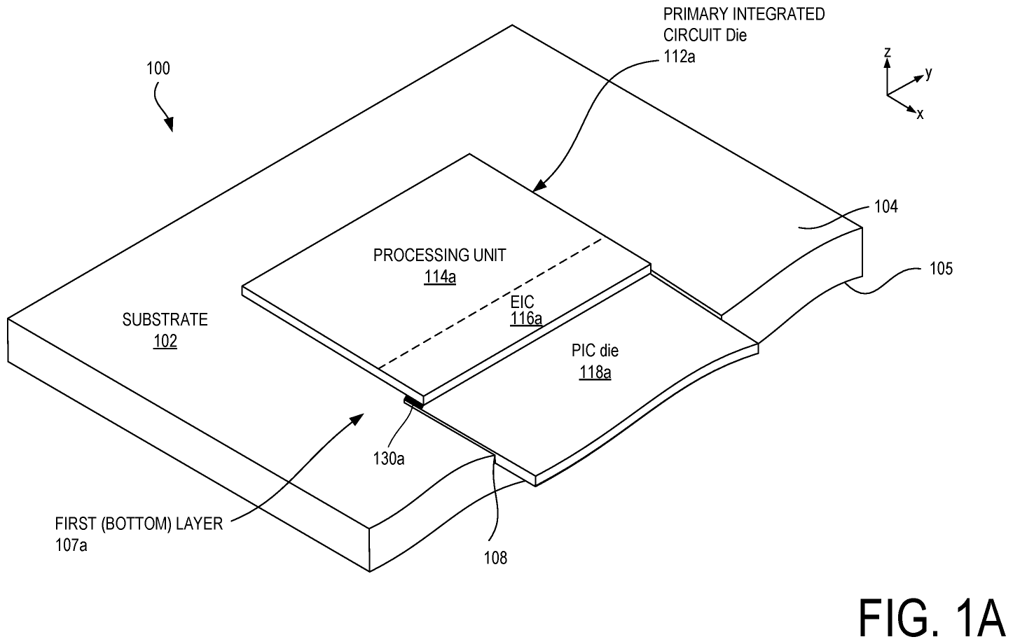

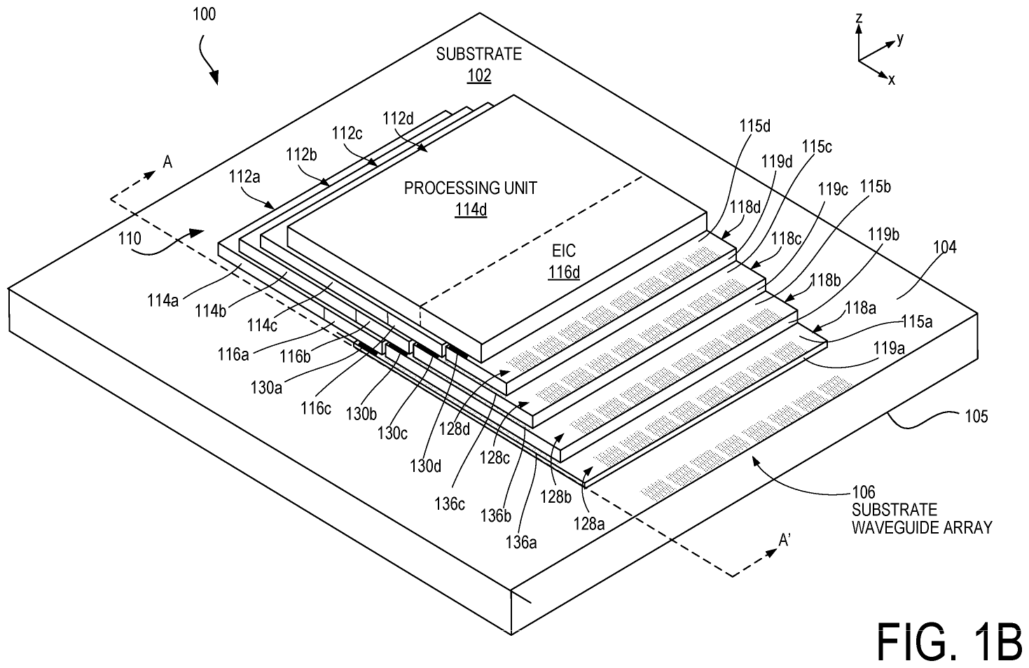

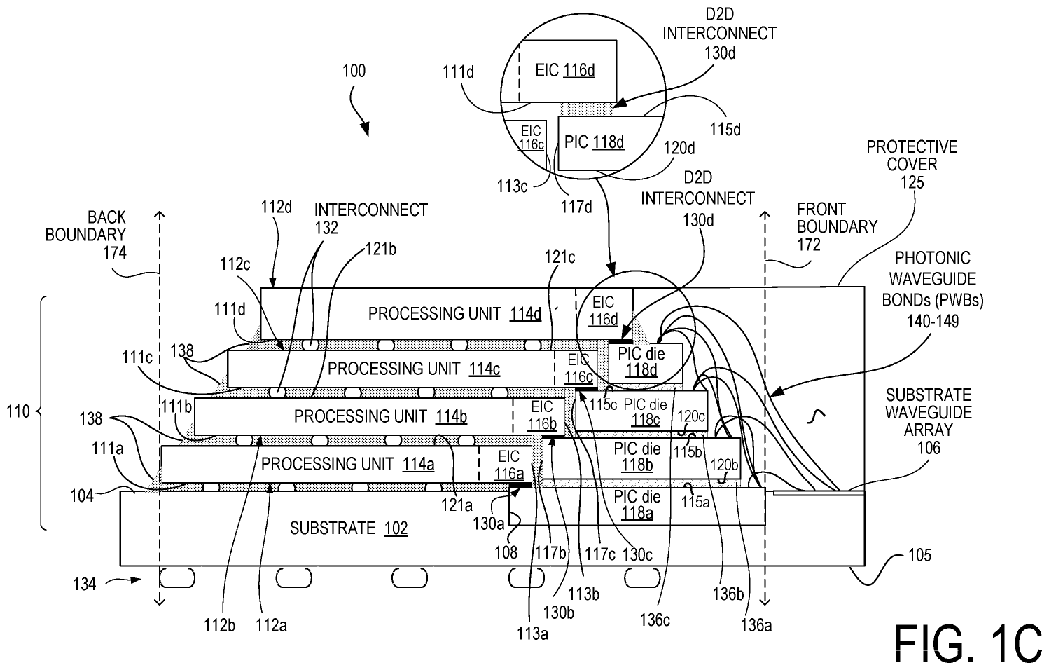

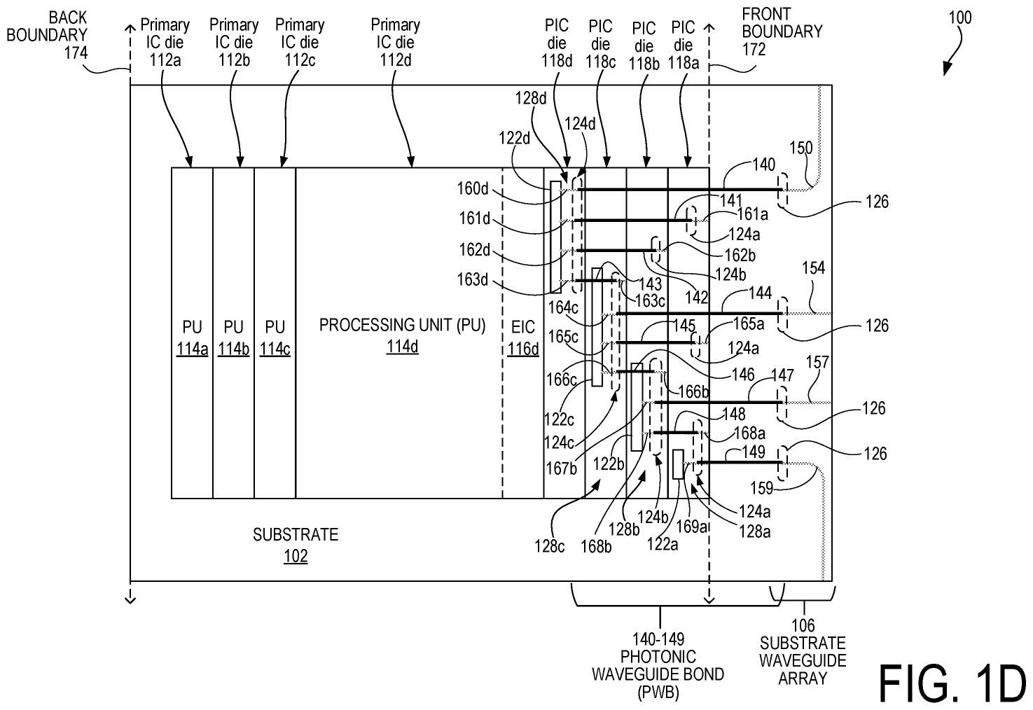

As used herein, the term “edge” can refer to a surface or face of a feature, component, die, block, or substrate. For example, the edge of a photonic integrated circuit (PIC), e.g., edges 119a-119d of PIC dies 118a-118d in FIG. 1B refers to edges (e.g., surfaces) of the PIC dies.

As used herein, the phrase “conductively coupled” refers to primary IC dies (with or either EIC integration), EIC dies, PIC dies, other components on the substrate, other components in other packages, etc. that are coupled to facilitate the flow of current between interlocking layers or components. For example, a processing unit can be conductively coupled to other processing units in the multi-die layered structure via conductive contacts and through silicon vias (TSVs). The processing units can also be conductively coupled to other components by an interposer embedded in a substrate to which the processing units are attached via conductive contacts, TSVs, and glass vias connecting the conductive contacts of a processing unit to the embedded interposer. As used herein, the phrase “optically coupled” refers to an interconnection of two components to facilitate the transfer of photonic signal (e.g., optical signal) using light waves. For example, a photonic integrated circuit (PIC) can be optically coupled to another PIC or a substrate via photonic waveguide bonds (PWBs), and/or micro-lens arrays, and/or any other suitable optical couplers. A PIC die may also be optically coupled and/or electrically coupled to an EIC.

Reference is now made to the drawings, which are not necessarily drawn to scale, wherein similar or same numbers may be used to designate same or similar parts in different figures. The use of similar or same numbers in different figures does not mean all figures including similar or same numbers constitute a single or same embodiment. Like numerals having different letter suffixes may represent different instances of similar components. The drawings illustrate generally, by way of example, but not by way of limitation, various embodiments discussed in the present document.

In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives within the scope of the claims.

FIGS. 1A-1B are perspective views of a portion of a first example integrated circuit component 100 with die-stacking. FIGS. 1A and 1B illustrate an integrated circuit component 100 with a single interlocking layer of a multi-die layered structure and with multiple interlocking layers of a multi-die layered structure, respectively. The integrated circuit component 100 is a multi-chip package comprising two or more primary integrated circuit dies in a multi-die layered structure 110 attached to a substrate 102 or to components embedded in the substrate 102. Each of the layers in the multi-die layered structure includes several integrated circuit dies including a primary integrated circuit die (e.g., 112a-112d), an electrical integrated circuit (EIC) (e.g., 116a-116d) (integrated with another die or embodied as a separate die), and a photonic integrated circuit (PIC) die (e.g., 118a-118d). In this example, the primary integrated circuit dies 112a-112d include respective processing units 114a-114d (e.g., central processing unit (CPU), graphic processing unit (GPU), advanced processing unit (APU), etc.), although the primary integrated circuit dies 112a-112d could also or alternatively include various other types of integrated circuits (e.g., memory, memory controller. I/O interface, network interface card, any other logic or storage component used in any type of a computing system or device, etc.). Although the integrated circuit component 100 is described herein as including one multi-die layered structure, it should be understood that one or more additional multi-die layered structures and/or one or more single-layer die structures may be attached to the substrate or to components embedded in the substrate and thus, could be included in the integrated circuit component 100.

The multi-die layered structure 110 is formed with interlocking layers (also referred to herein as “layers” or individually as “layer”) of integrated circuit dies. Each layer includes a primary integrated circuit die (e.g., 112a-112d), a PIC die (e.g., 118-118d), and an EIC (e.g., 116a-116d). A first (bottom) layer 107a in the multi-die layered structure 110 includes a first primary integrated circuit die 112a (e.g., processing unit 114a with an integrated EIC 116a) and a first PIC die 118a. The first primary integrated circuit die 112a in the first (bottom) layer 107a of the multi-die layered structure can be attached to the substrate 102 or to components embedded in the substrate 102 by conductive contacts (e.g., pads) on a lower surface of the first primary integrated circuit die attaching to conductive contacts on the surface of the substrate 102 or on the surface of a component embedded in the substrate 102.

The first PIC die 118a included in the bottom layer 107a of the multi-die layered structure 110 can be embedded in the substrate 102. A recess 108 is formed in the substrate 102 and extends partially through the substrate 102 from an upper surface 104 of the substrate 102. Only a portion of the recess 108 is shown in FIG. 1A. The recess 108 is sized and shaped to accommodate at least a portion of the first PIC die that is included in the bottom layer 107a of the multi-die layered structure 110. In this example, the first PIC die 118a is part of the bottom layer 107a of the multi-die layered structure 110 and is partially received in the recess 108. The edges of the first PIC die 118a extend in the z-direction slightly above the upper surface 104 of the substrate 102, such that an upper surface 115a of the first PIC die 118a is horizontally spaced from a plane defined by the upper surface 104 of the substrate 102. In other examples, the upper surface of the first PIC die 118a may be coplanar with the upper surface 104 of the substrate 102. The first PIC die 118a can be embedded in the substrate 102 and can be attached to the primary integrated circuit die 112a by an interconnect 130a.

The substrate 102 can be a printed circuit board or comprise glass, ceramic, or other suitable material. A printed circuit board can comprise one or more layers of non-conductive substrate material, such as an epoxy resin and glass fabric composite (e.g., FR-4) with conductive traces between layers of the non-conductive substrate material. Non-limiting examples of glass, of which substrate 102 may be comprised, include any one or more of aluminosilicate, borosilicate, alumino-borosilicate, silica, and fused silica. Glass used in substrate 102 may comprise Silicon and Oxygen, as well as any one or more of Aluminum, Boron, Magnesium, Calcium, Barium, Tin, Sodium, Potassium, Strontium, Phosphorus, Zirconium, Lithium, Titanium, and Zinc. In at least one example, glass used in substrate 102 comprises at least 23 percent Silicon and at least 26 percent Oxygen by weight, and may further comprise at least 5 percent Aluminum by weight. In at least one example, the substrate 102 may comprise an amorphous solid glass layer.

FIG. 1C is a cross-sectional view of the first example integrated circuit component 100 of FIG. 1B taken along the line A-A′. FIG. 1C shows additional details of the multi-die layered structure 110 and further includes a substrate waveguide array 106 and photonic waveguide bonds (PWBs) 140-149. FIG. 1C illustrates the optical co-packaging on substrate 102 (e.g., glass) with three-dimensional die-stacking and each primary integrated circuit die 112a-112d including a respective processing unit 114a-114d. The processing units 114a-114d can be identical dies or different functional dies (e.g., central processing unit (CPU), graphics processing unit (GPU), accelerator processing unit (APU), etc.). Alternatively, one or more of the processor units 114a-114d can be other functional dies such as a memory unit, a memory controller, an I/O interface, a networking interface card, etc.

For purposes of explanation and description, a front boundary 172 and a back boundary 174 define the space within which the multi-die layered structure 110 is disposed. The front boundary 172 corresponds to a vertical plane that is substantially perpendicular to the upper surface 104 of the substrate 102 and substantially coplanar with a front facing edge 119a of the first (bottom) PIC die 118a. The back boundary 174 corresponds to another vertical plane that is substantially parallel to the front boundary 172, substantially perpendicular to the upper surface 104 of the substrate 102, and substantially coplanar with a back facing edge of the first (bottom) primary IC die 112a. In this example, the front facing edges of PIC dies 118a-118d and are disposed toward and oppose (e.g., face or abut) the front boundary 172 at varying distances. The back facing edges of the primary IC dies 112a-112d are disposed toward and oppose (e.g., face or abut) the back boundary 174 at varying distances. It should be noted, that the primary IC dies 112a-112d could be made in various sizes to minimize or eliminate or change the varying distances between the back facing edges and the back boundary 174.

Each interlocking layer of the multi-die layered structure 110 includes one primary integrated circuit die (e.g., 112a-112d) and one PIC die (e.g., 118a-118d). In each layer of the multi-die layered structure 110, a lower surface of a front end of a primary integrated circuit die is attached to an upper surface of a back end of a PIC die by a suitable device-to-device (D2D) interconnect that enables electrical and/or optical conductivity. One nonlimiting example of a device-to-device interconnect includes corresponding conductive contacts (e.g., pads, solder balls) on the opposing surfaces of the attached dies. The EICs can be configured to translate electrical signals (e.g., from the processing unit or other component) to optical signals for the attached PIC die, and the translate optical signals received from the PIC die into electrical signals for the processing unit (or other component). An EIC may be integrated with a processing unit (or other primary integrated circuit) on the same die. The EIC can be disposed at a front end of the primary integrated circuit die to provide the interconnect to the PIC die and to communicate through the interconnect to the PIC die. In other scenarios, an EIC may be fabricated on its own separate die or integrated with a PIC on the same die, as will be further shown and described herein.

The attachment of a front end of a primary integrated circuit die (e.g., 112a-112d) and a back end of a PIC die (e.g., 118a-118d) creates an interlocking layer having a single stairstep shape. The stairstep is created because a back portion of the upper surface of the PIC die faces a front portion of the lower surface of the primary integrated circuit die, but the remaining portion of the upper surface of the PIC die is not covered by the primary integrated circuit die.

The multi-die layered structure 110 shown in FIGS. 1B-1C includes four interlocking layers. However, it should be apparent that two, three, four, or more interlocking layers could be used to form a multi-die layered structure. In the first (bottom) layer, which is adjacent to and attached to the substrate 102, the first primary integrated circuit die 112a is attached to components in the first PIC die 118a by an interconnect 130a from a front portion of a lower surface 111a of the primary integrated circuit die 112a to a back portion of an upper surface 115a of the PIC die 118a. In one example, the interconnect 130a is achieved by attaching conductive contacts (e.g., pads, solder balls) that are on the lower surface of the primary integrated circuit die 112a to corresponding conductive contacts on the upper surface 115a of the PIC die 118a. A first EIC 116a is integrated with processing unit 114a on the primary IC die 112a. The first EIC 116a is disposed at a front end of primary IC die 112a to provide the interconnect 130a to and communication with the first PIC die 118a.

A second layer of the multi-die layered structure 110 is interlocked with the first (bottom) layer (first primary IC die 112a and first PIC die 118a). In the second layer, a second primary integrated circuit die 112b is attached to components in a second PIC die 118b by an interconnect 130b from a front portion of a lower surface 111b of the second primary integrated circuit die 112b to a back portion of a upper surface 115b of the second PIC die 118b. In one example, the interconnect 130b is achieved by attaching conductive contacts (e.g., pads) that are on the lower surface 111b of the second primary integrated circuit die 112b to corresponding conductive contacts on the upper surface 115b of the second PIC die 118b. A second EIC 116b is integrated with processing unit 114b on the second primary IC die 112b. The second EIC 116b is disposed at a front end of primary IC die 112b to provide the interconnect 130b to and communication with the second PIC die 118b. When the first layer and the second layer are interlocked, the first primary IC die 112a of the first layer is substantially horizontally aligned with the second PIC die 118b of the second layer. As shown in FIG. 1C, an inner edge 113a of the first primary integrated circuit die 112a opposes an inner edge 117b of the second PIC die 118b.

A third layer of the multi-die layered structure 110 is interlocked with the second layer (second primary IC die 112b and second PIC die 118b). In the third layer, a third primary integrated circuit die 112c is attached to components in a third PIC die 118c by an interconnect 130c from a front portion of a lower surface 111c of the third primary integrated circuit die 112c to a back portion of an upper surface 115c of the third PIC die 118c. In one example, the interconnect 130c is achieved by attaching conductive contacts (e.g., pads) that are on the lower surface 111c of the third primary integrated circuit die 112c to corresponding conductive contacts on the upper surface 115c of the third PIC die 118c. A third EIC 116c is integrated with processing unit 114c on the third primary IC die 112c. The third EIC 116c is disposed at a front end of third primary IC die 112c to provide the interconnect 130c to and communication with the third PIC die 118c. When the second layer and the third layer are interlocked, the second primary IC die 112b of the second layer is substantially horizontally aligned with the third PIC die 118c of the third layer. As shown in FIG. 1C, an inner edge 113b of the second primary integrated circuit die 112b opposes an inner edge 117c of the third PIC die 118c.

A fourth (top) layer of the multi-die layered structure 110 is interlocked with the third layer (third primary IC die 112c and third PIC die 118c). In the fourth (top) layer, a fourth primary integrated circuit die 112d is attached to components in a fourth PIC die 118d by an interconnect 130d from a front portion of a lower surface 111d of the fourth primary integrated circuit die 112d to a back portion of an upper surface 115d of the fourth PIC die 118d. In one example, the interconnect 130d is achieved by attaching conductive contacts (e.g., pads) that are on the lower surface 111d of the fourth primary integrated circuit die 112d to corresponding conductive contacts on the upper surface 115d of the fourth PIC die 118d. A fourth EIC 116d is integrated with processing unit 114d on the fourth primary IC die 112d. The fourth EIC 116d is disposed at a front end of the fourth primary IC die 112d to provide the interconnect 130d and communicate to the fourth PIC die 118d. When the third layer and the fourth layer are interlocked, the third primary IC die 112c of the third layer is substantially horizontally aligned with the fourth PIC die 118d of the fourth layer. As shown in FIG. 1C, an inner edge 113c of the third primary integrated circuit die 112c opposes an inner edge 117d of the fourth PIC die 118d.

A primary integrated circuit die of the top layer in a multi-die layered structure, such as the fourth primary integrated circuit die 112d in this example, may be thicker (measured in a z-direction) than the other primary integrated circuit dies in the stack for heat spreading purposes. For example, the fourth primary integrated circuit die 112d, which is part of the fourth and top layers of the multi-die layered structure 110, is thicker than the other primary integrated circuit dies 112a, 112b, and 112c, which are part of lower layers in the stack.

Bonding material is used to bond the interlocking layers to the package. For example, PIC dies 118b-118d can be bonded to each other. In particular, a lower surface 120b of the second PIC die 118b can be attached to the upper surface 115a of the first PIC die 118a by a bonding layer 136a, a lower surface 120c of the third PIC die 118c can be attached to the upper surface 115b of the second PIC die 118b by a bonding layer 136b, and a lower surface 120d of the fourth PIC die 118d can be attached to the upper surface 115c of the third PIC die 118c by a bonding layer 136c. The bonding material used in bonding layers 136a-136c can be an epoxy or other suitable adhesive.

As shown in FIG. 1C, a plurality of interconnects 132 are used to for power delivery to each of the primary integrated circuit dies 112a-112d. As previously described, the first (bottom layer) primary integrated circuit die 112a can be attached to the substrate 102 or to components embedded in the substrate. Interconnects 132 can provide the attachment. The lower surface 111b of the second primary integrated circuit die 112b in the second layer can be attached, by multiple interconnects 132, to the upper surface 115a of the first primary integrated circuit die 112a in the first layer. The lower surface 111c of the third primary integrated circuit die 112c in the third layer can be attached, by multiple interconnects 132, to the upper surface 115b of the second primary integrated circuit die 112b in the second layer The lower surface 111d of the fourth primary integrated circuit die 112d in the fourth layer can be attached, by multiple interconnects 132, to the upper surface 115c of the third primary integrated circuit die 112c in the third layer. The interconnects 132 conductively couple the primary integrated circuit dies to solder balls 134 on the lower surface 105 of the substrate 102. The solder balls 134 enable connection of the integrated circuit component 100 to a printed circuit board (PCB) or a socket. The integrated circuit component 100 may be attached to a socket via a ball grid array (BGA), land grid array (LGA), or other suitable manner.

Optionally, interconnects 132 may also be used to carry small quantities of data to the substrate 102 from the primary integrated circuit dies 112a-112b, or from one primary integrated circuit die to another in the multi-die layered structure 110. To enable the transfer of data, through silicon vias (TSVs) can be embedded in the primary IC dies 112a-112c. TSVs are vertical electrical connections that pass through a silicon die. TSVs can be used to connect the interconnects 132 from the lower surface 111d of the fourth (top) layer primary integrated circuit die 112d through the third primary integrated circuit die 112c, from the lower surface 111c of the third primary integrated circuit die 112c through the second primary integrated circuit die 112b, and from the lower surface 111b of the second primary integrated circuit die 112b through the first (bottom) primary integrated circuit die 112a. The fourth (top) primary integrated circuit die 112d may or may not have TSVs, as the power delivery and optional small data transfers can be accomplished through the TSVs in the other three primary IC dies below the top layer. To enable the transfer of data through the glass substrate, through glass vias (TGVs) can be embedded in the substrate 102 to connect the interconnects 132 from the lower surface of the first primary integrated circuit die 112a through the substrate 102 to the solder balls 134.

In the example integrated circuit component 100, the PIC dies 118a-118d are customized for each primary integrated circuit die 112a-112d (e.g., processing units 114a-114d). The interlocking of the layers of the multi-die layered structure 110 creates a stairstep or tiered shape by the PIC dies 118a-118d. This stairstep shape is created due to the increasing length, measured in the x-direction, of each PIC die from the top layer containing the fourth PIC die 118d to the bottom layer containing the first PIC die 118a. The length in the x-direction of the fourth PIC die 118d in the top layer is the shortest (or smallest), with the lengths of the other PIC dies 118c, 118b, and 118a becoming increasingly longer (or greater), such that the length of the first PIC die 118a in the bottom layer is the longest (or greatest). The stairstep or tiered shape results in a portion of the upper surface of each PIC die being exposed and not overlapped by the next higher PIC die, due to the next higher PIC die having a shorter length.

The stairstep configuration of the PICs 118a-118d enable the use of waveguide arrays 128a-128d to facilitate transmission of optical signals encoded with information or data between the primary integrated circuit dies (e.g., processing units 114a-114d) in the multi-die layered structure 110 and one or more other primary integrated circuit dies on the multi-die layered structure 110 or one or more waveguides in a waveguide array 106 in the substrate. The waveguide array 106 in the substrate 102 facilitates transmission of optical signals between one or more of the primary integrated circuit dies 112a-112d in the multi-die layered structure 110 and other primary integrated circuit dies in other multi-die layered structures or single layer die structures on the same substrate, on a different substrate, or in a different integrated circuit components (packaged or unpackaged)).

Waveguides are used in optical circuitry to confine and guide optical signals (and other electromagnetic signals). Generally, a waveguide is a hollow structure having a uniform cross-section that transmits optical signals using reflection from the inner walls of the hollow structure. Nonlimiting examples of possible cross-sectional shapes that may be used for a waveguide include, rectangular, circular, elliptical, single-ridged, and double-ridged. A core of a waveguide is typically made from a material having a high refractive index, while a cladding that surrounds the core has a low refractive index to confine the light within the waveguide. Waveguides used in PIC dies (e.g., PIC dies 118a-118d) can include planar dielectric waveguides to confine and guide optical signals in integrated optical circuitry (also referred to as planar lightwave circuits (PLCs)). Waveguides in a glass substrate (e.g., substrate 102) can also include planar dielectric waveguides. Generally, any suitable waveguides for carrying optical signals with low loss, or with components or circuitry to minimize loss, may be used as the PIC waveguides and the substrate waveguides.

FIG. 1D is a top plan view of the first example integrated circuit component 100 of FIG. 1C. In FIG. 1D, the PWBs 140-149 have a linear depiction for ease of illustration and description. FIG. 1D shows the PIC waveguides as having various spacing across each of the PIC dies, and the substrate waveguides having spacing that aligns with the PIC waveguides to which they are connected. It should be noted that any suitable spacing of waveguides within a PIC die and a substrate may be used and may depend on the particular implementation, needs, manufacturing capabilities, costs, and/or any other relevant criteria. It should also be noted that FIG. 1D has fewer PIC waveguides and substrate waveguides than FIG. 1B. This is for case of illustration and description only. Any number of PIC waveguides and substrate waveguides may be included in the PIC dies and substrate of integrated circuit component 100.

As shown in FIGS. 1B and 1D, PIC dies 118a-118d comprise respective a PIC waveguide arrays 128a-128b disposed in the exposed front end portions of the PIC dies 118a-118d. A waveguide array in a PIC die includes at least one waveguide. It should be noted, however, that a waveguide array (e.g., 128a-128d) can include any number of waveguides. The number of waveguides to be provided in a given PIC die can depend at least in part on the number of other PIC dies within the multi-die layered structure to which the PIC die is connected, whether the PIC die is connected to a waveguide in the substrate, and how much bandwidth is needed for communication to and from the primary integrated circuit die attached to the PIC die. Generally, the greater the bandwidth requirements, the greater the number of waveguides that may be provided in a waveguide array in the PIC die.

In one example, the substrate waveguide array 106 includes one waveguide for each PWB used to connect the substrate to one of the PIC dies. In some scenarios, one or more of the PIC dies 118a-118d may only be connected to other components within the multi-die layered structure 110. In this scenario, the substrate waveguide array 106 may not be connected to the PIC dies that only communicate with other components within the multi-die layered structure 110. In another example, one or more PIC dies 118a-118d may not be connected to any of the other components in the multi-die layered structure 110 and may only be connected to one or more waveguides in the substrate waveguide array 106.

In at least one example, first ends of the waveguides in the PIC waveguide arrays 128a-128d extend to front facing edges 119a, 119b, 119c, and 119d of the PIC dies 118a-118d, respectively. Each waveguide in a PIC die can include a connection point (e.g., 124a-124d shown in FIG. 1D) in the exposed upper surface of the PIC die or in the front facing edge (e.g., 119a-119d shown in FIG. 1B) of the PIC die. Opposite ends of the waveguides in the PIC dies are connected to photonic circuitry 122a, 122b, 122c, and 122d in the respective PIC dies 118a-118d. Photonic circuitry 122a-122d may include any suitable circuitry and other components to enable sending optical signals to and receiving optical signals from the attached EIC 116a-116d. By way of example, the photonic circuitry may include lasers, optical amplifiers, modulator, demodulators, photodetectors, etc. The PIC dies 118a-118d can also include optical switches to re-route the light from one source (e.g., primary integrated circuit die 112a-112b) to many destinations.

The substrate waveguide array 106 includes one or more waveguides and can be disposed in an upper surface 104 of the substrate 102 with at least a portion of the substrate waveguides being substantially perpendicular to the front boundary 172 of the multi-die layered structure 110. The first ends of the substrate waveguides may be adjacent to or have any suitable spacing outwardly from the front boundary 172. Generally, the substrate waveguides are sufficiently spaced from the front boundary 172 to allow PWBs 140-149 to connect the substrate waveguides of the substrate waveguide array 106 with corresponding PIC waveguides of the PIC waveguide arrays 128a-128d in the exposed portions of the upper surfaces of the PIC dies 118a-118d. If substrate 102 contains only the one multi-die layered structure 110, then each of substrate waveguides may have a second end that extends to an outer edge of the substrate 102 to connect to other packaged integrated circuit components or other devices via optical fibers, for example. If the substrate 102 contains one or more other components, then one or more substrate waveguides may be routed to the various other components on the substrate 102, or otherwise optically coupled in a suitable manner to the various other components on the substrate 102. In addition, or alternatively, one or more substrate waveguides may be routed to an edge of the substrate to connect with other packaged integrated circuit components or other devices.

FIGS. 1C-1D illustrate photonic waveguide bonds (PWBs) 140-149 that optically connect the waveguides in each PIC die 118a-118d to respective waveguides in another PIC die 118a-118d or in the substrate 102. A PWB includes a single-mode polymer waveguide having a three-dimensional freeform geometry, as shown in FIG. 1C, for example. The number of PWBs that are used depends on the number of waveguide-to-waveguide connections within the integrated circuit component 100 between the PIC dies 118a-118d and between PIC dies 118a-118d and the substrate 102. The integrated circuit component 100 may include a protective cover 125 (e.g., mechanical container) over the freeform PWBs 140-149 to protect the PWBs. Any material in close contact with the PWBs should have a refractive index that does not interfere with the PWBs or increase signal loss.

For illustration purposes, in FIG. 1D, each PIC waveguide array 128a-128d includes four waveguides, and the substrate waveguide array 106 also includes four waveguides. FIG. 1D further depicts ten PWBs 140-149 optically connecting waveguides in the PIC dies to waveguides in other PIC dies and in the substrate. For ease of illustration and description, FIG. 1D depicts the minimum number of waveguides in the example integrated circuit component 100 that can provide optical connections between each PIC die pair in the multi-die layered structure 110 and between the substrate and each PIC die in the multi-die layered structure 110. Furthermore, the PWBs 140-149 in FIG. 1D are linearly depicted for clarity, although the three-dimensional and freeform features of PWBs may not necessarily produce a strictly linear appearance.

In this example, the first PIC waveguide array 128a of the first PIC die 118a includes PIC waveguides 161a, 165a, 168a, and 169a. The second PIC waveguide array 128b on the second PIC die 118b includes PIC waveguides 162b, 166b, 167b, and 168b. The third PIC waveguide array 128c on the third PIC die 118c include PIC waveguides 163c, 164c, 165c, and 166c. The fourth PIC waveguide array 128d of the fourth PIC die 118d includes PIC waveguides 160d, 161d, 162d, and 163d. In the fourth PIC die 118d, PIC waveguide 160d is optically connected to substrate waveguide 150 by PWB 140; PIC waveguide 161d is optically connected to PIC waveguide 161a in the first PIC die 118a by PWB 141; PIC waveguide 162d is optically connected to PIC waveguide 162b in the second PIC die 118b by PWB 142; and PIC waveguide 163d is optically connected to PIC waveguide 163c in the third PIC die 118c by PWB 143. In the third PIC die 118c, PIC waveguide 164c is optically connected to substrate waveguide 154 by PWB 144; PIC waveguide 165c is optically connected to PIC waveguide 165a in the first PIC die 118a by PWB 145; PIC waveguide 166c is optically connected to PIC waveguide 166b in the second PIC die 118b by PWB 146. In the second PIC die 118b, PIC waveguide 167b is optically connected to substrate waveguide 157 by PWB 147; and PIC waveguide 168b is optically connected to PIC waveguide 168a in the first PIC die 118a by PWB 148. In the first PIC die 118a, PIC waveguide 169a is optically connected to substrate waveguide 159 by PWB 149.

The ends of each PWB terminate at different waveguides and are coupled respectively to the different waveguides to enable the flow of optical signals through the two waveguides and the PWB. Connection points are indicated in each PIC waveguide array 128a-128d and in the substrate waveguide array 106 by dashed ovals. In PIC die 118a, connection points 124a couple one end of each PWB 141, 145, 148, and 149 to a respective PIC waveguide 161a, 165a, 168a, and 169a. In PIC die 118b, connection points 124b couple one end of each PWB 142, 146, 147, and 148 to a respective PIC waveguide 162b, 166b, 167b, and 168b. In PIC die 118c, connection points 124c couple one end of each PWB 143, 144, 145, and 146 to a respective PIC waveguide 163c, 164c, 165c, and 166c. Connection points 124d couple one end of each PWB 140, 141, 142, and 143 to a respective PIC waveguide 160d, 161d, 162d, and 163d. In substrate waveguide array 106, connection points 126 couple one end of each PWB 140, 144, 147, and 149 to a respective substrate waveguide 150, 154, 157, and 159.

In one example, the connection points 124a-124d in the PIC dies 118a-118d and the connection points 126 in substrate 102, represent an evanescent mode of coupling. Evanescent wave coupling between two optical waveguides can be achieved when the cores are placed close together so that an evanescent field in one waveguide excites an optical wave in the other waveguide. Accordingly, a portion of a PWB extending from one end of the PWB may run substantially parallel to or in the same path as, and in close proximity to, an end portion of a substrate waveguide in the substrate 102 to achieve evanescent coupling. Evanescent wave coupling may also be used in the PIC waveguides. For example, a portion of a PWB extending from an end of the PWB may run substantially parallel to or in the same path as, and in close proximity to, an end portion of a PIC waveguide in the PIC die to which the substrate waveguide is connected.

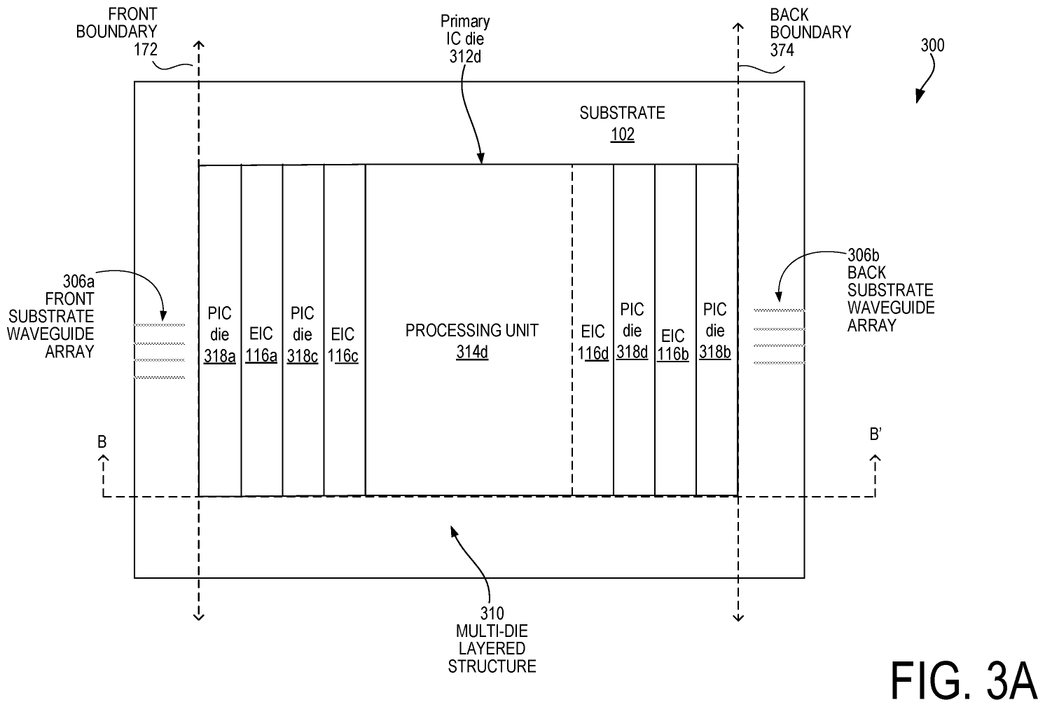

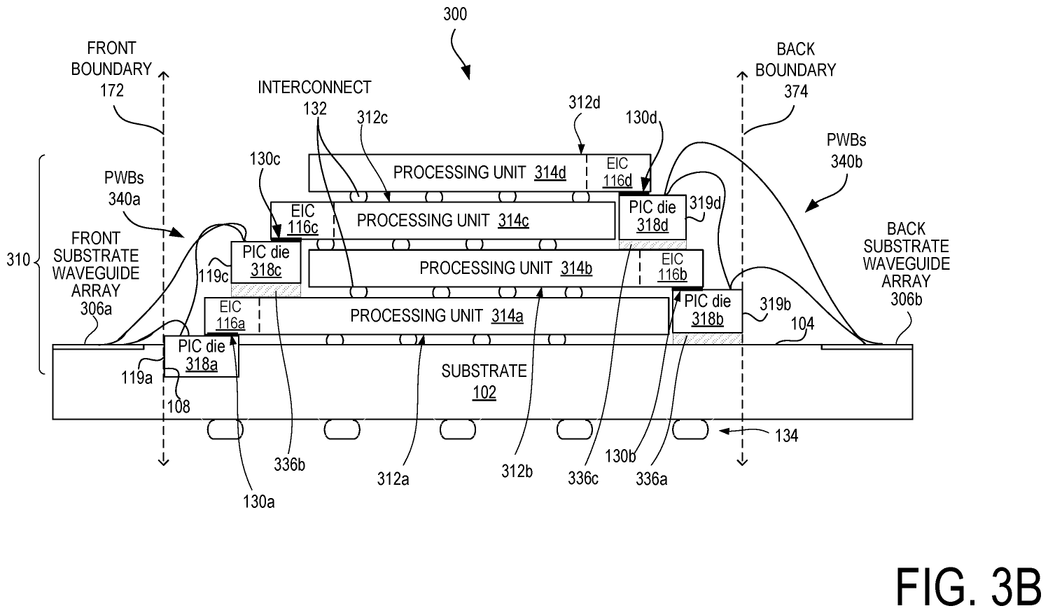

Although the EICs are illustrated in FIGS. 1A-1D as being integrated with processing units 114a-114d in primary integrated circuit dies 112a-112d, in some embodiments, some or all of the EIC functionality can be implemented as separate integrated circuit dies attached to the PIC dies 118a-118d, integrated into the same integrated circuit die as one or more optical components (e.g., PIC dies 116a-116d), or integrated into another integrated circuit component or chiplet that implements functionality other than enabling communication and data transfer between the electronic and photonic domains. At least some of these other embodiments will be further shown and described herein with reference to FIGS. 3A-5B.

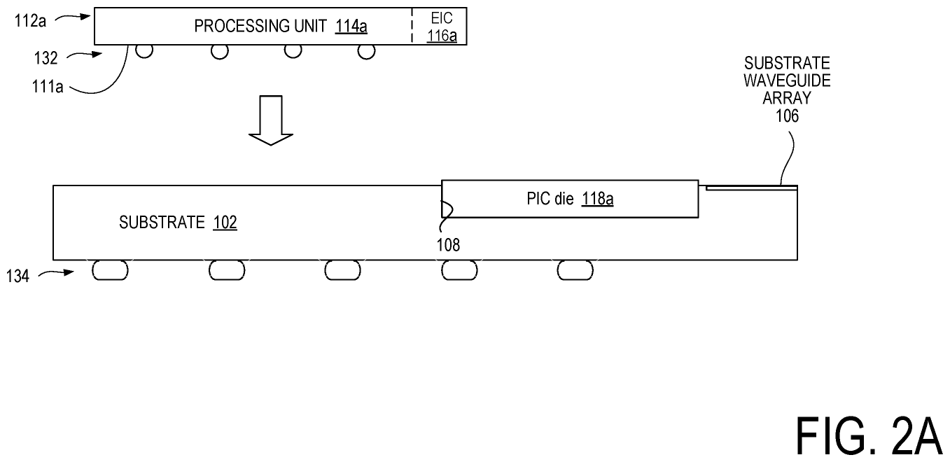

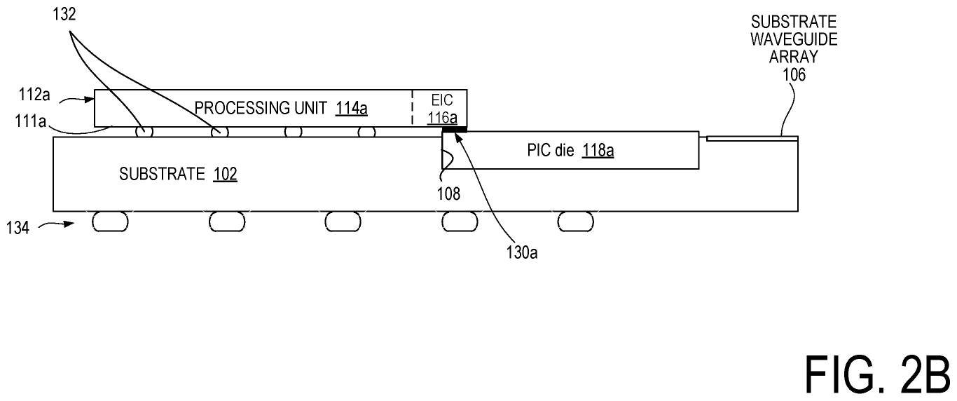

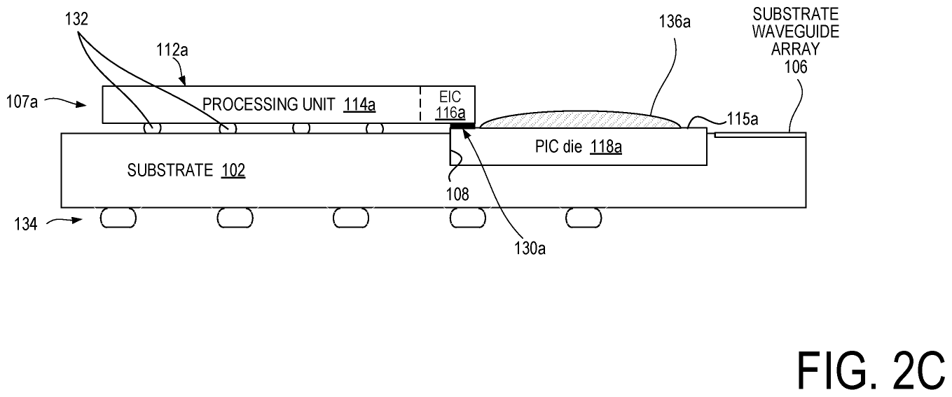

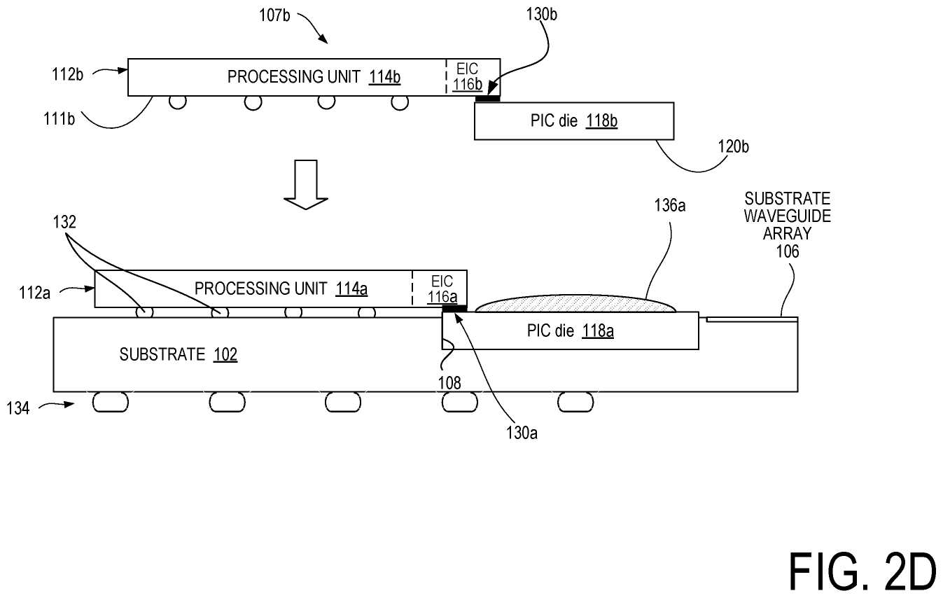

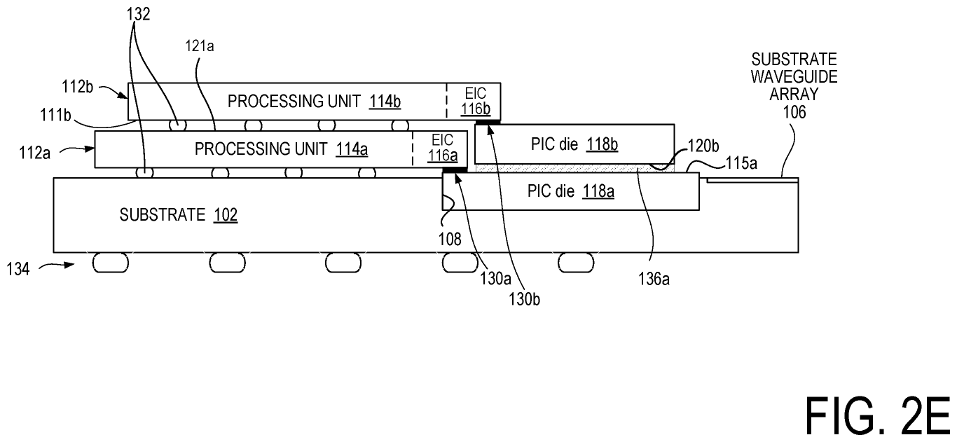

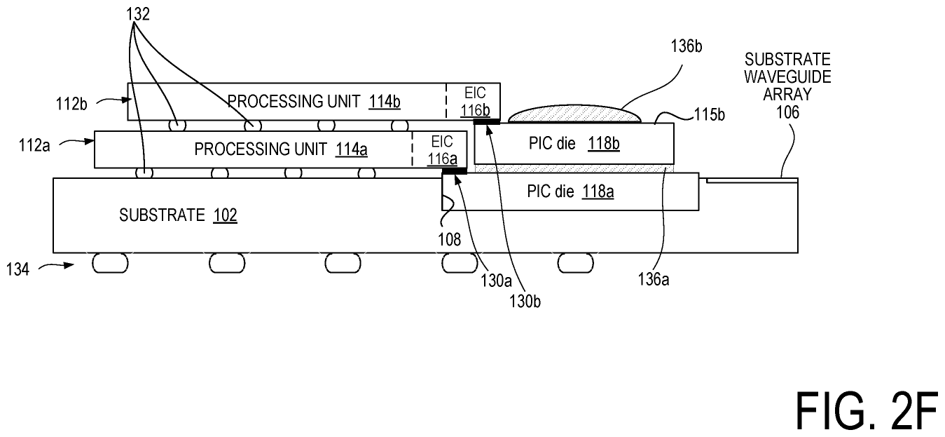

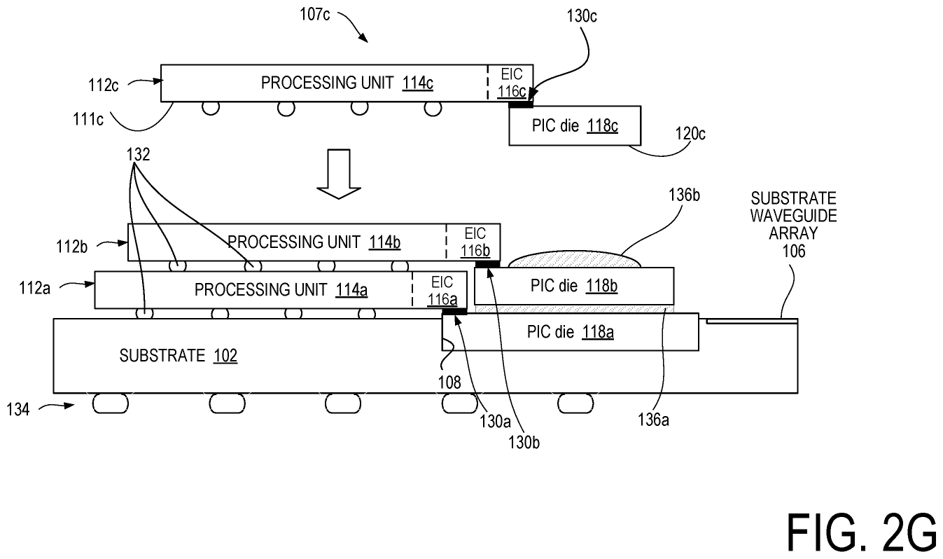

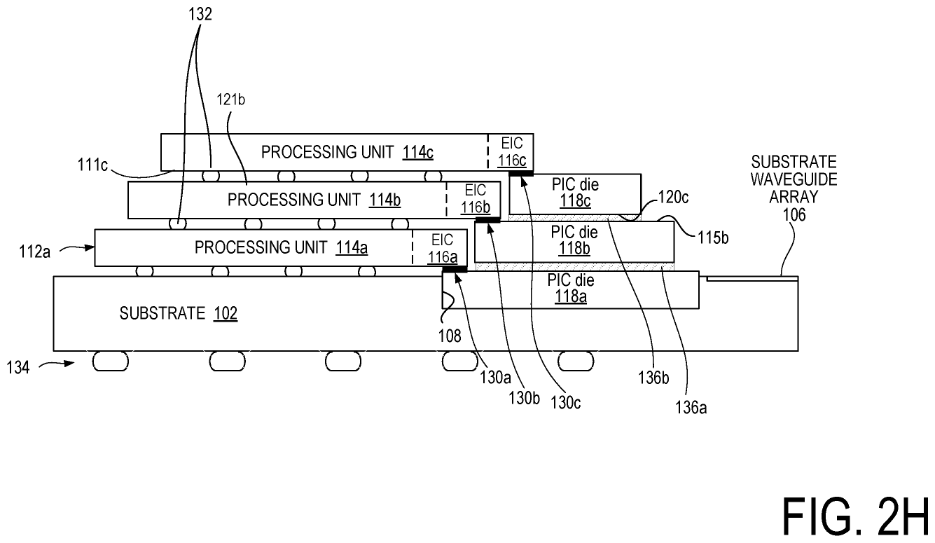

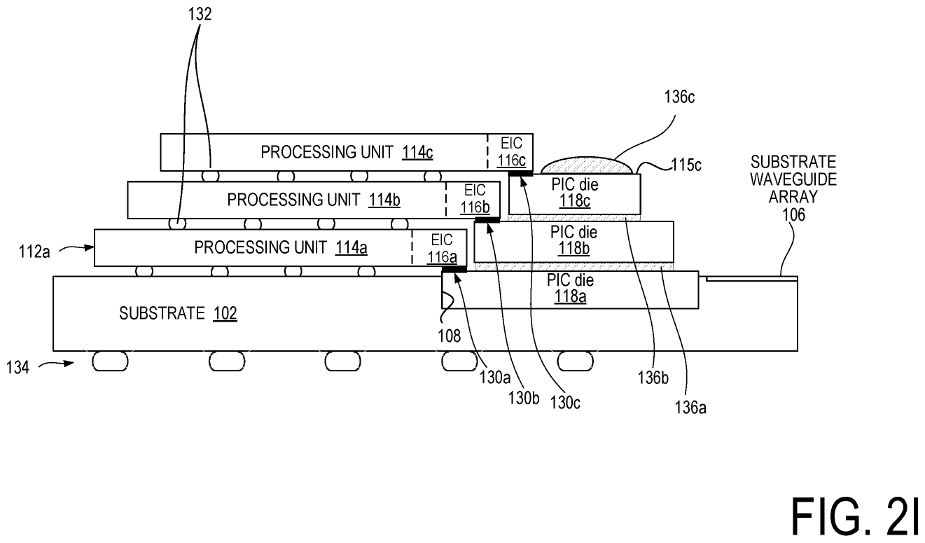

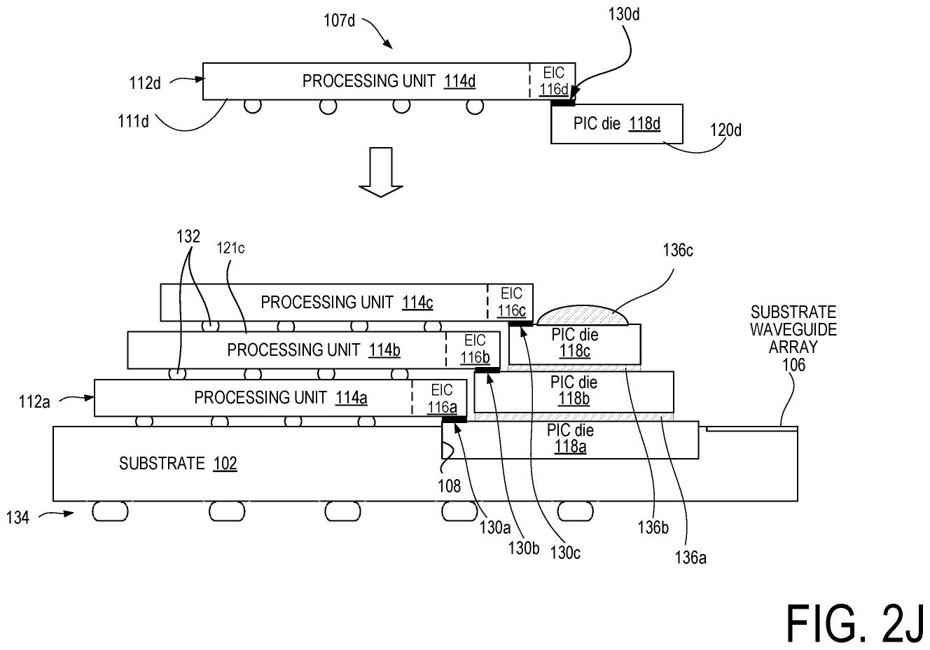

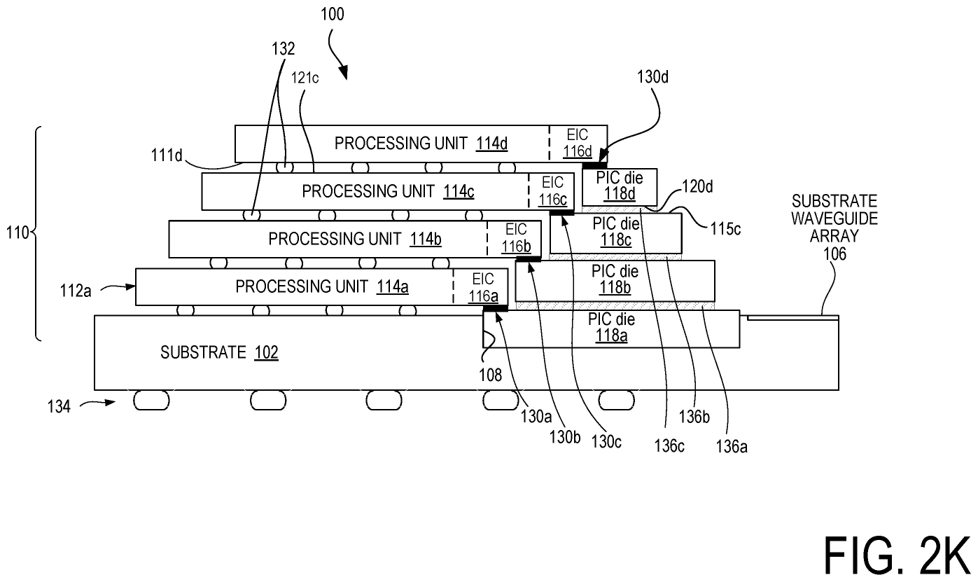

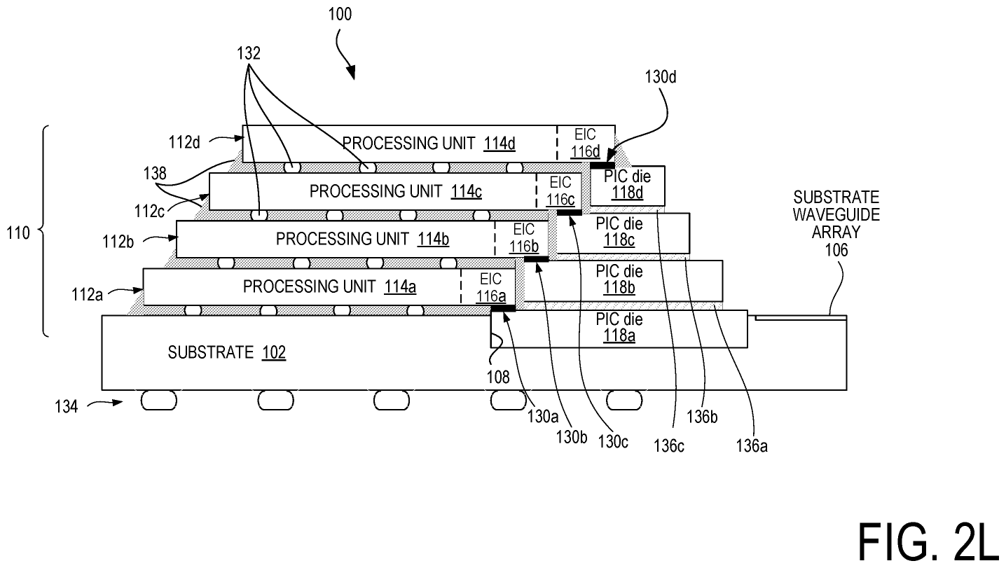

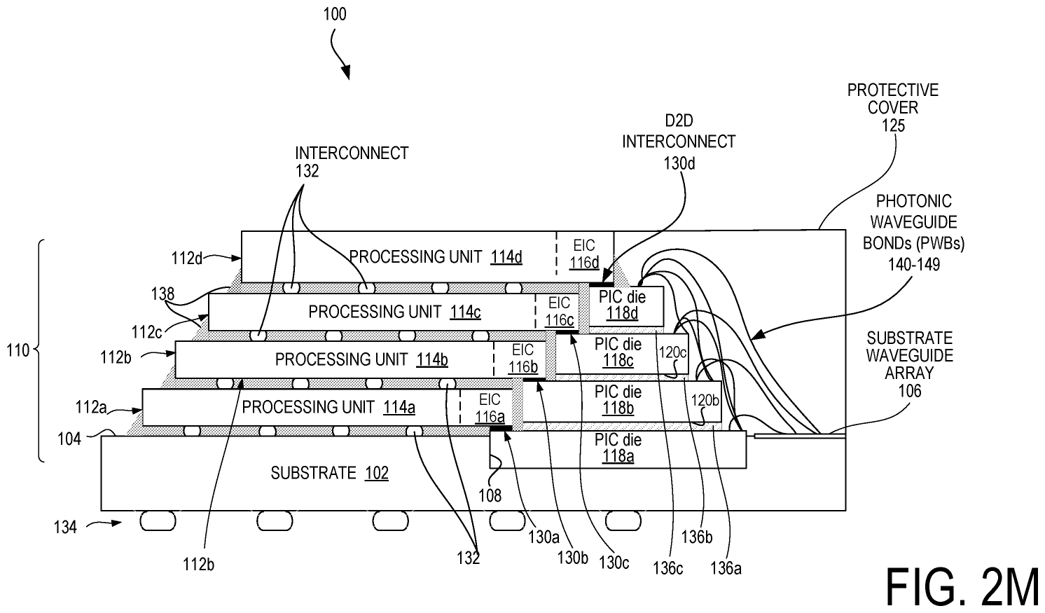

FIGS. 2A-2M are cross-sectional side views of the first example integrated circuit component 100 of FIGS. 1B-1D at various stages of manufacture. The cross-section is taken along A-A′ in FIG. 1B. FIG. 2A illustrates the integrated circuit component 100 after embedding the first (bottom) PIC die 118a in the recess 108 of the glass substrate 102. The first primary IC die 112a including the processing unit 114a and integrated EIC 116a are prepared to be attached.

FIG. 2B illustrates the integrated circuit component 100 after attachment of the primary IC die 112a to the substrate and to the PIC die 118a. The first processing unit 114a is attached to the substrate by interconnects 132, and the first EIC 116a is attached to the first PIC die 118a by a D2D interconnect. This creates the first (bottom) interlocking layer 107a (also referred to as “first layer”) of the multi-die layered structure. When attached, the lower surface 111a of the first primary integrated circuit die 112a opposes an upper surface 104 of the substrate, and the first PIC die 118a is seated within the recess 108 in the substrate. FIG. 2C illustrates a nonconductive bonding layer 136a, such as epoxy, dispensed on an upper surface 115a of the first PIC die 118a.

FIG. 2D illustrates the pre-assembly of the second interlocking layer 107b (also referred to as “second layer”) to be attached to the package. The second interlocking layer 107b includes the second primary IC die 112b (including the second processing unit 114b and second EIC 116b) attached to the second PIC die 118b. The second EIC 116b is attached to the second PIC die 118b by a D2D interconnect 130b.

FIG. 2E illustrates the integrated circuit component 100 after attachment of the second layer 107b to an upper side of the first layer 107a in the multi-die layered structure. The second processing unit 114b is attached by interconnects 132 to the first processing unit 114a, and the second PIC die 118b is bonded to the first PIC die 118a. When attached, a lower surface 111b of the second primary integrated circuit die 112b opposes an upper surface 121a of the first primary integrated circuit die 112a, and a lower surface 120b of the second PIC die 118b opposes an upper surface 115a of the first PIC die 118a. FIG. 2F illustrates a nonconductive bonding layer 136b, such as epoxy, dispensed on an upper surface 115b of the second PIC die 118b.

FIG. 2G illustrates the pre-assembly of the third interlocking layer 107c (also referred to as “third layer”) to be attached to the package. The third layer 107c includes the third primary IC die 112c (including the third processing unit 114c and third EIC 116c) attached to the third PIC die 118c. The third EIC 116c is attached to the third PIC die 118c by a D2D interconnect 130c.

FIG. 2H illustrates the integrated circuit component 100 after attachment of the third layer 107c to the second layer 107b to an upper side of the first layer 107a in the multi-die layered structure. The third processing unit 114c is attached by interconnects 132 to the second processing unit 114b, and the third PIC die 118c is bonded to the second PIC die 118b. When attached, a lower surface 111c of the third primary integrated circuit die 112c opposes an upper surface 121b of the second primary integrated circuit die 112b, and a lower surface 120c of the third PIC die 118c opposes an upper surface 115b of the second PIC die 118b. FIG. 2I illustrates a nonconductive bonding layer 136c, such as epoxy, dispensed on an upper surface 115c of the third PIC die 118c.

FIG. 2J illustrates the pre-assembly of the fourth interlocking layer (also referred to as “fourth layer”) to be attached to the package. The fourth layer 107d includes the fourth primary IC die 112d (including the fourth processing unit 114d and fourth EIC 116d) attached to the fourth PIC die 118d. The fourth EIC 116d is attached to the fourth PIC die 118d by a D2D interconnect 130d.

FIG. 2K illustrates the integrated circuit component 100 after attachment of the fourth layer 107d to an upper side of the third layer 107c in the multi-die layered structure. The fourth processing unit 114d is attached by interconnects 132 to the third processing unit 114c, and the fourth PIC die 118d is bonded to the third PIC die 118c. When attached, a lower surface 111d of the fourth primary integrated circuit die 112d opposes an upper surface 121c of the third primary integrated circuit die 112c, and a lower surface 120d of the fourth PIC die 118d opposes an upper surface 115c of the third PIC die 118c.

FIG. 2L illustrates the application of encapsulation 138 (or underfill) if needed. FIG. 2M illustrates the completion of all PIC die-to-PIC die and PIC die-to-substrate PWB 140-149 connections. The completed, packaged integrated circuit component 100 may then be attached (e.g., inserted or plugged) into a PCB or a socket.

FIG. 3A is a top plan view of a second example integrated circuit component 300 and FIG. 3B is a cross-sectional view of component 300 taken along line B-B′ of FIG. 3A, and showing photonic waveguide bonds 340a and 340b. The integrated circuit component 300 includes a second example multi-die layered structure 310 and two substrate waveguide arrays 306a and 306b. The component 300 is similar to the integrated circuit component 100 (with similar parts having the same reference numbers as FIGS. 1A-1D and 2A-2M), but with the PIC dies 318a-318d and corresponding EICs 116a-116d alternating between front and back sides of the multi-die layered structure 310 with each interlocking layer. For simplicity, PWBs and PIC waveguide arrays in the second example integrated circuit component 300, which are similar to PIC waveguide arrays 128a-128d of integrated circuit component 100, are omitted in FIG. 3A.

With reference to FIG. 3A, a back boundary 374 corresponds to a vertical plane that is substantially parallel to the front boundary 172, substantially perpendicular to the upper surface 104 of the substrate 102, and substantially coplanar with a back facing edge 319b of the second PIC die 318b in the second interlocking layer of the multi-die layered structure 310. In this example, front facing edges 119a and 119c of the first and third PIC dies 318a and 318c and front facing edges of the corresponding attached first and third EICs 116a and 116c of the first and third interlocking layers (e.g., 107a and 107c), respectively, are disposed toward and oppose (e.g., face or abut) the front boundary 172. Back facing edges 319b and 319d of the second and fourth PIC dies 318b and 318d and back facing edges of the corresponding attached second and fourth EICs 116b and 116d of the second and fourth interlocking layers (e.g., 107b and 107d), respectively, are disposed toward and oppose (e.g., face or abut) the back boundary 374.

Each of the primary IC dies 312a, 312b, 312c, and 312d in component 300 includes processing units 314a, 314b, 314c, and 314d and respective integrated EICs 116a-116d. The primary IC dies 312a-312d may be various sizes to enable the interlocking arrangement. The interlocking layers are oriented with every other PIC die and attached EIC disposed toward the front boundary 172 and the other layers are oriented with the remaining PIC dies and attached EICs disposed toward the back boundary 374. The EICs 116a-116d, can use the same attachments (e.g., interconnects 130a-130d) to respective PIC dies 318a-318d as described with reference to component 100. The processing units 314a-314d can also use the same attachments (e.g., interconnects 132) to each other and the substrate 102 for power delivery and optionally, for small data transfers. In at least one example, PIC dies 318a-318d in component 300 may be a substantially uniform size, although this could vary depending on the particular implementation.

Bonding layers 336a-336c are used to bond the interlocking layers to the package. In this example, PIC die 318a can be embedded in the recess 108 in the substrate 102, PIC die 318b can be attached to the substrate 102, and each of the other PIC dies 318c-318d can be attached to a primary IC die 312a-312b, respectively. For example, a lower surface of the PIC die 318b in the second interlocking layer can be attached to an upper surface 104 of substrate 102 by bonding layer 336a, a lower surface of PIC die 318c in the third interlocking layer can be attached to an upper surface of the first primary IC die 312a by a bonding layer 336b, and a lower surface of PIC die 318d in the fourth (top) interlocking layer can be attached to an upper surface of the second primary IC die 312b by a bonding layer 336c. The bonding material used in bonding layers 336a-336c can be an epoxy or other suitable adhesive.

Since PIC dies 318a and 318c are disposed on one side (e.g., toward the front boundary 172) of the multi-die layered structure 310, and PIC dies 318b and 318d are disposed on an opposite side (e.g., toward the back boundary 374), two substrate waveguide arrays 306a and 306b may be provided in substrate 102 adjacent to the front boundary 172 and the back boundary 374, respectively. In this example, one or more waveguides in PIC dies disposed toward the front boundary 172 (e.g., waveguides in PIC dies 318a and 318c) may be attached to waveguides in the front substrate waveguide array 306a with one or more corresponding PWBs 340a. Waveguides in PIC dies disposed toward the back boundary 374 (e.g., waveguides in PIC dies 318b and 318d) may be attached to waveguides in the back substrate waveguide array 306b with one or more respective PWBs 340b. In addition, one or more waveguides in PIC dies disposed toward the front boundary 172 (e.g., 318a and 318c) may be attached to each other with one or more respective PWBs 340a. One or more waveguides in PIC dies disposed toward the back boundary 374 (e.g., 318b and 318d) may be attached to each other with one or more respective PWBs 340a.

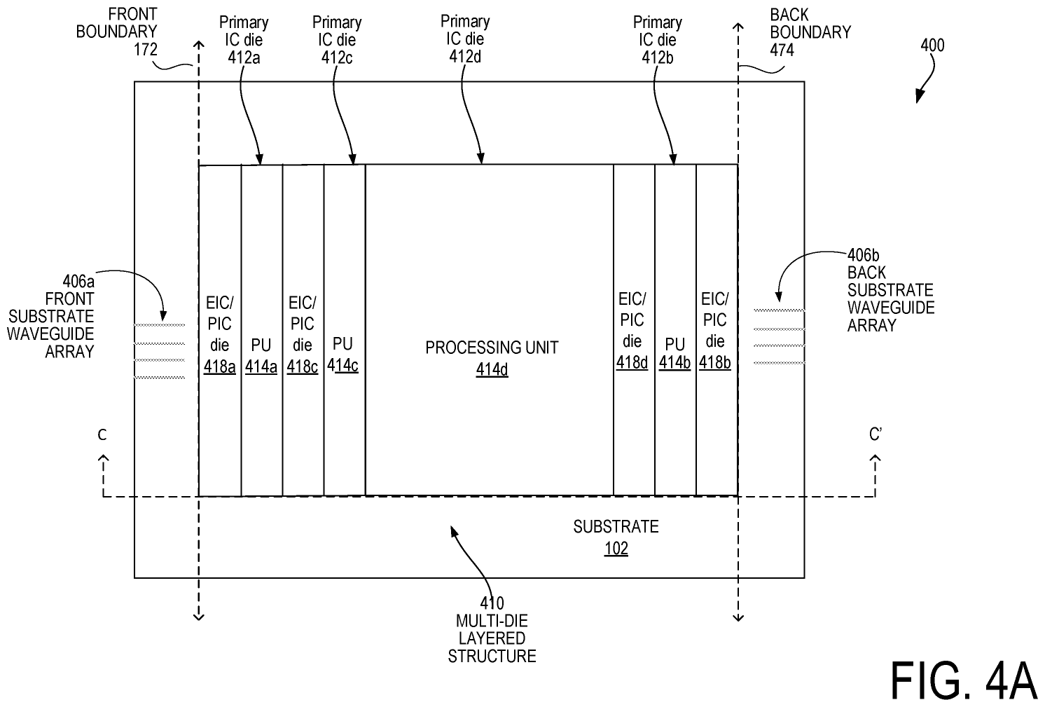

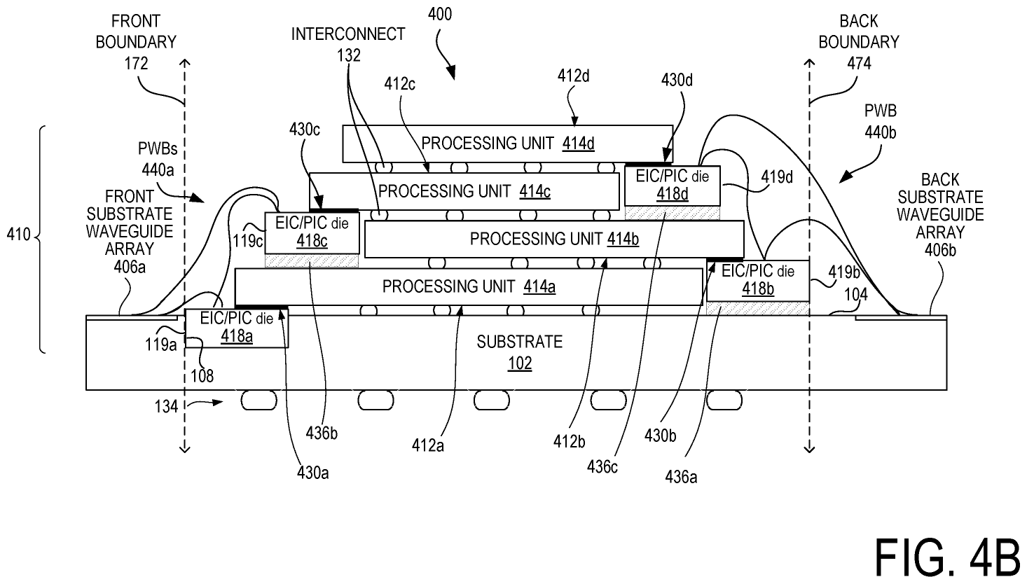

FIG. 4A is a top plan view of a third example integrated circuit component 400 and FIG. 4B is a cross-sectional view of component 400 taken along line C-C′ of FIG. 4A, and showing photonic waveguide bonds 440a and 440b. The integrated circuit component 400 includes a third example multi-die layered structure 410 and two substrate waveguide arrays 406a and 406b. The component 400 is similar to the integrated circuit component 100 (with similar parts having the same reference numbers as FIGS. 1A-1D and 2A-2M), but with EICs being integrated with PIC dies, and with combined EIC/PIC dies 418a, 418b, 418c, and 418d alternating between front and back sides of the multi-die layered structure 410 with each interlocking layer. For simplicity, PWBs and PIC waveguide arrays in the integrated circuit component 400, which are similar to PIC waveguide arrays 128a-128d of integrated circuit component 100, are omitted in FIG. 4A.

With reference to FIG. 4A, a back boundary 474 corresponds to a vertical plane that is substantially parallel to the front boundary 172, substantially perpendicular to the upper surface 104 of the substrate 102, and substantially coplanar with a back facing edge 419b of the second EIC/PIC die 418b in the second interlocking layer of the multi-die layered structure 410. In this example, front facing edges 119a and 119c of the EIC/PIC dies 418a and 418c of the first and third interlocking layers (e.g., 107a and 107c), respectively, are disposed toward and oppose (e.g., face or abut) the front boundary 172. Back facing edges 419b and 419d of the EIC/PIC dies 418b and 418d of the second and fourth interlocking layers (e.g., 107b and 107d), respectively, are disposed toward and oppose (e.g., face or abut) the back boundary 474.

Each of the primary IC dies 412a, 412b, 412c, and 412d in component 400 includes a respective processing unit 414a, 414b, 414c, and 414d, without an integrated EIC. The primary IC dies 412a-412d may be various sizes to enable the interlocking arrangement. The interlocking layers are oriented with every other (e.g., alternating) EIC/PIC die disposed toward the front boundary 172 and the other layers are oriented with the remaining EIC/PIC dies disposed toward the back boundary 474. The processing units 414a-414d may be attached to the EIC/PIC dies 418a-418d using interconnects 430a, 430b, 430c, and 430d, respectively, such as conductive contacts (e.g., pads, solder balls) and an I/O interface to communicate with the EICs in the EIC/PIC dies 418a-418d. The processing units 414a-414d can also use the same attachments (e.g., interconnects 132) to each other and to the substrate 102 for power delivery and optionally, for small data transfers. In at least one example, the EIC/PIC dies 418a-418d in component 400 may be a substantially uniform size, although this could vary depending on the particular implementation.

Bonding layers 436a, 436b, and 436c are used to bond the interlocking layers to the package. In this example, EIC/PIC die 418a can be embedded in the recess 108 in the substrate 102, EIC/PIC die 418b can be attached to the substrate 102, and each of the other EIC/PIC dies 418c-418d can be attached to a primary IC die 412a-412b below that PIC die in the stack. For example, a lower surface of the EIC/PIC die 418b in the second interlocking layer can be attached to an upper surface 104 of substrate 102 by bonding layer 436a, a lower surface of EIC/PIC die 418c in the third interlocking layer can be attached to an upper surface of the first primary IC die 412a by a bonding layer 436b, and a lower surface of EIC/PIC die 418d in the fourth (top) interlocking layer can be attached to an upper surface of the second primary IC die 412b by a bonding layer 436c. The bonding material used in bonding layers 436a-436c can be an epoxy or other suitable adhesive.

Since EIC/PIC dies 418a and 418c are disposed on one side (e.g., toward the front boundary 172) of the multi-die layered structure 410, and EIC/PIC dies 418b and 418d are disposed on an opposite side (e.g., toward the back boundary 474), two substrate waveguides 406a and 406b may be provided in substrate 102 adjacent to the front boundary 172 and the back boundary 474, respectively. In this example, one or more waveguides in EIC/PIC dies disposed toward the front boundary 172 (e.g., waveguides in EIC/PIC dies 418a and 418c) may be attached to waveguides in the front substrate waveguide array 406a with one or more corresponding PWBs 440a. Waveguides in EIC/PIC dies disposed toward the back boundary 474 (e.g., waveguides in EIC/PIC dies 418b and 418d) may be attached to waveguides in the back substrate waveguide array 406b with one or more corresponding PWBs 440b. In addition, one or more waveguides in EIC/PIC dies disposed toward the front boundary 172 (e.g., waveguides in EIC/PIC dies 418a and 418c) may be attached to each other with one or more corresponding PWBs 440a. One or more waveguides in EIC/PIC dies disposed toward the back boundary 474 (e.g., waveguides in EIC/PIC dies 418b and 418d) may be attached to each other with one or more corresponding PWBs 440b.

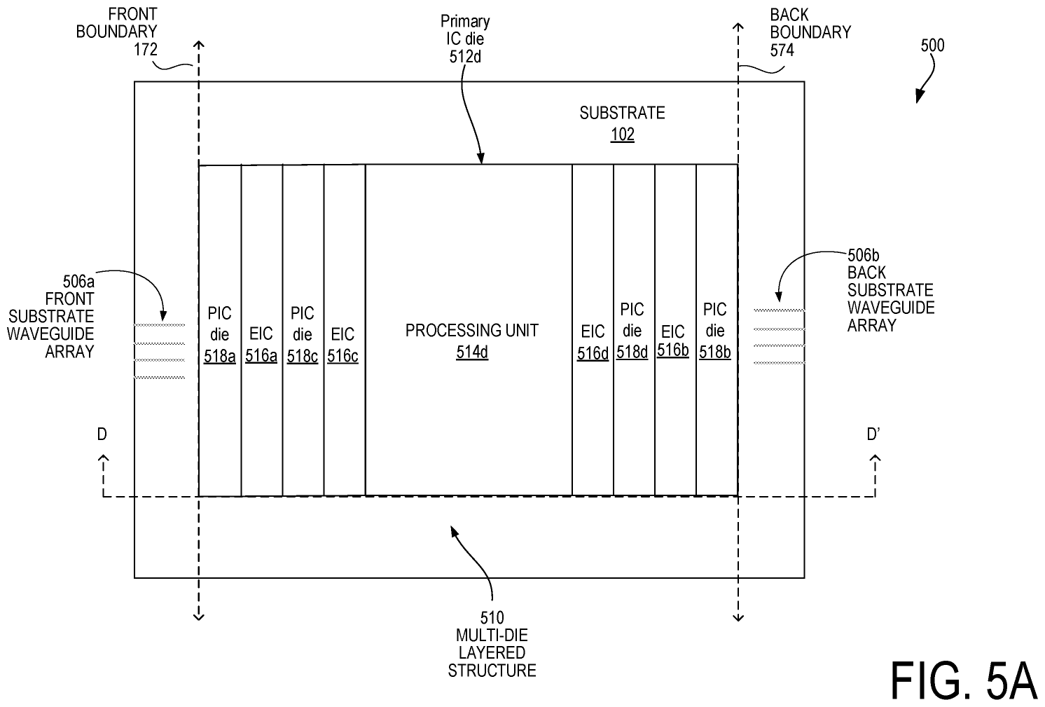

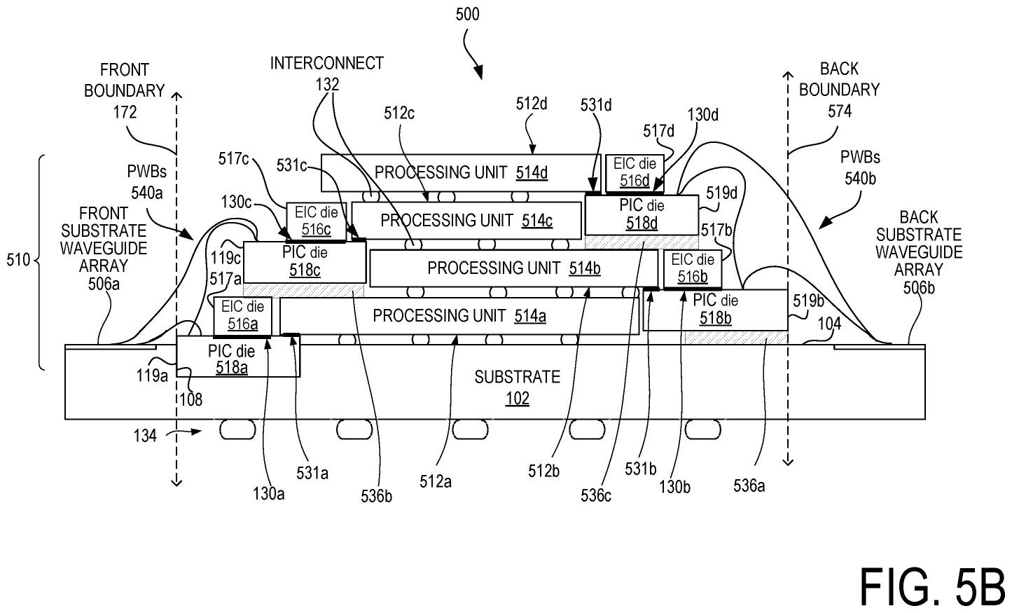

FIG. 5A is a top plan view of a fourth example integrated circuit component 500 and FIG. 5B is a cross-sectional view of component 500 taken along line D-D′ of FIG. 5A, and showing photonic waveguide bonds 540a and 540b. The integrated circuit component 500 includes a fourth example multi-die layered structure 510 and two substrate waveguide arrays 506a and 506b. The component 500 is similar to the integrated circuit component 100 (with similar parts having the same reference numbers as FIGS. 1A-1D and 2A-2M), but with EICs implemented as separate dies in each interlocking layer of the multi-die layered structure 510, and with the PIC dies and corresponding EIC dies 516a-516d alternating between front and back sides of the layered structure 510 with each interlocking layer. For simplicity, PWBs and PIC waveguide arrays in the integrated circuit component 500, which are similar to PIC waveguide arrays 128a-128d of integrated circuit component 100, are omitted in FIG. 5A.

With reference to FIG. 5A, a back boundary 574 corresponds to a vertical plane that is substantially parallel to the front boundary 172, substantially perpendicular to the upper surface 104 of the substrate 102, and substantially coplanar with a back facing edge 519b of the second EIC/PIC die 518b in the second interlocking layer of the multi-die layered structure 510. FIG. 5B illustrates that front facing edges 119a and 119c of the PIC dies 518a and 518c and front facing edges 517a and 517c of the corresponding attached EICs 516a and 516c of the first and third interlocking layers (e.g., 107a and 107c), respectively, are disposed toward and oppose (e.g., face or abut) the front boundary 172. Back facing edges 519b and 519d of the PIC dies 518b and 518d and back facing edges 517b and 517d of corresponding attached EICs 516b and 516d of the second and fourth interlocking layers (e.g., 107b and 107d), respectively, are disposed toward and oppose (e.g., face or abut) the back boundary 574.

In this example, the first EIC 516a is substantially horizontally aligned with the first primary integrated circuit die 512a, In this example, the first EICs are substantially horizontally aligned with the primary integrated circuit die in the same interlocking layer. For example, the first EIC 516a is substantially horizontally aligned with the first primary integrated circuit die 512a, the second EIC 516b is substantially horizontally aligned with the second primary integrated circuit die 512b, the third EIC 516c is substantially horizontally aligned with the third primary integrated circuit die 512c, and the fourth EIC 516d is substantially horizontally aligned with the fourth primary integrated circuit die 512d.

Each of the primary IC dies 512a-512d in component 500 includes a processing unit 514a, 514b, 514c, and 514d, without an integrated EIC. The primary IC dies 512a-512d may be various sizes to enable the interlocking arrangement. The interlocking layers are oriented with every other PIC die and attached EIC disposed toward the front boundary 172 and the other layers are oriented with the remaining PIC dies and attached EICs disposed toward the back boundary 574. The EICs 516a-516d, can use the same attachments (e.g., D2D interconnects 130a-130d) to respective PIC dies 518a-518d as described with reference to component 100. The processing units 514a-514d are also attached to PIC dies 518a-518d, respectively. Primary IC dies 512a-512d (e.g., processing units 514a-514d in this example) are attached to components in corresponding PIC dies 518a-518d by respective interconnects 531a-531d. In one example, the interconnects 531a, 531b, 531c, and 531d are achieved by attaching conductive contacts (e.g., pads, solder balls) that are on the lower surface of each primary IC die 512a-512d to corresponding conductive contacts on an upper surface of the corresponding PIC die 518a-518d. The EICs 516a-516d communicate to the processing units 514a-514d through the respective PIC dies 518a-518d interconnected between the EICs and the processing units. The processing units 514a-514d can also use the same attachments (e.g., interconnects 132) to each other and to the substrate 102 for power delivery and optionally, for small data transfers. In at least one example, PIC dies 518a-518d in component 500 may be a substantially uniform size, although this could vary depending on the particular implementation.

Bonding layers 536a-536c are used to bond the interlocking layers to the package. In this example, PIC die 518a can be embedded in the recess 108 in the substrate 102, PIC die 518b can be attached to the substrate 102, and each of the other PIC dies 518c-518d can be attached to a primary IC die 512a-512b and/or an EIC die 516a-516b below that PIC die in the stack. For example, a lower surface of the PIC die 518b in the second interlocking layer can be attached to an upper surface 104 of substrate 102 by bonding layer 536a, a lower surface of PIC die 518c in the third interlocking layer can be partially attached to an upper surface of the first primary IC die 512a and partially attached to an upper surface of the first EIC die 516a by the same bonding layer 536b, and a lower surface of PIC die 518d in the fourth (top) interlocking layer can be partially attached to an upper surface of the second primary IC die 512b and partially attached to an upper surface of the second EIC die 516b by the same bonding layer 536c. The bonding material used in bonding layers 536a-536c can be an epoxy or other suitable adhesive.

Since PIC dies 518a and 518c are disposed on one side (e.g., toward the front boundary 172) of the multi-die layered structure 510, and PIC dies 518b and 518d are disposed on an opposite side (e.g., toward the back boundary 574), two substrate waveguides 506a and 506b may be provided in substrate 102 adjacent to the front boundary 172 and the back boundary 574, respectively. In this example, one or more waveguides in PIC dies disposed toward the front boundary 172 (e.g., waveguides in PIC dies 518a and 518c) may be attached to waveguides in the front substrate waveguide array 506a with one or more corresponding PWBs 540a. Waveguides in PIC dies disposed toward the back boundary 574 (e.g., waveguides in PIC dies 518b and 518d) may be attached to waveguides in the back substrate waveguide array 506b with one or more corresponding PWBs 540b. In addition, one or more waveguides in PIC dies disposed toward the front boundary 172 (e.g., 518a and 518c) may be attached to each other with one or more corresponding PWBs 540a. One or more waveguides in PIC dies disposed toward the back boundary 574 (e.g., 518b and 518d) may be attached to each other with one or more corresponding PWBs 540b.

During the manufacturing of the example integrated circuit component 500, the separate EIC dies 516a-516d can be pre-assembled with the primary IC dies 512a-512d (e.g., processing units 514a-514d) and the PIC dies 118a-118d to form a sub-assembly interlocking layer before attaching to the package.

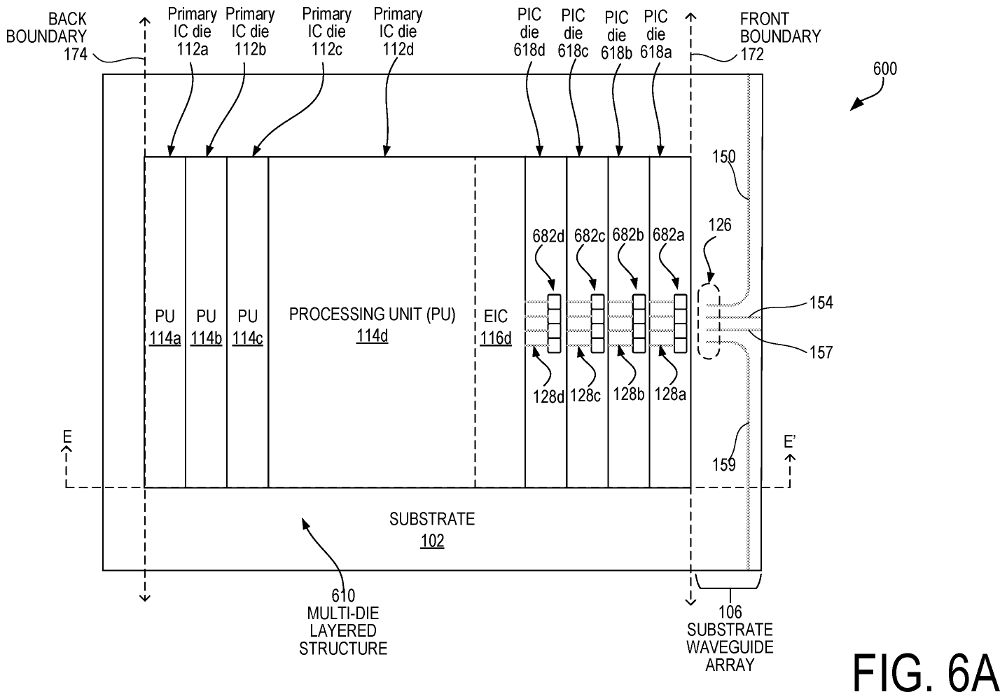

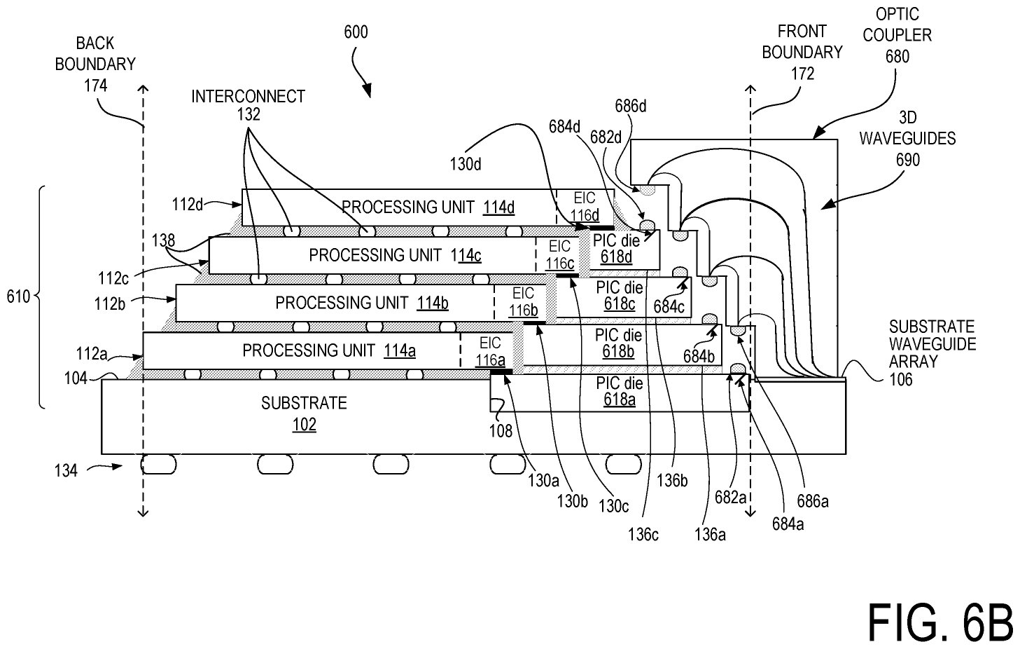

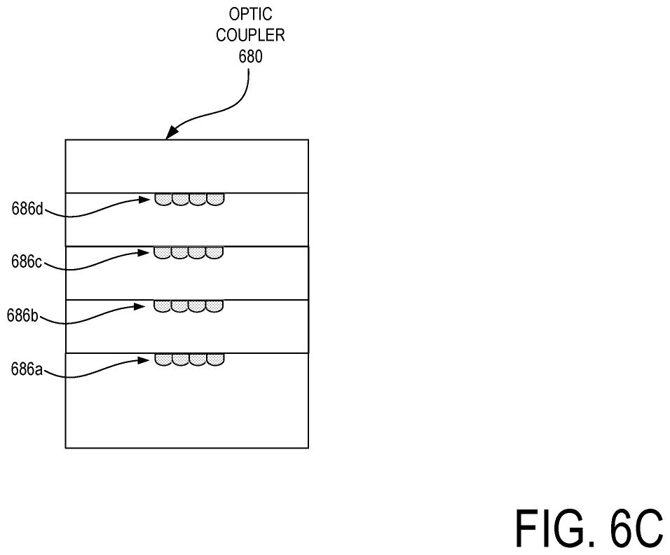

FIG. 6A is a top plan view of a fifth example integrated circuit component 600 and FIG. 6B is a cross-sectional view of component 600 taken along line E-E′ of FIG. 6A. FIG. 6B includes the addition of an optical coupler 680. The integrated circuit component 600 includes a fifth example multi-die layered structure 610. The component 600 is similar to the integrated circuit component 100 (with similar parts having the same reference numbers as FIGS. 1A-1D and 2A-2M), but includes an optical coupler 680 using micro-lens arrays to connect to the PIC waveguides in PIC dies 618a-618d. The multi-die layered structure 610 is similar to the multi-die layered structure 110 of component 100, with variations in the PIC dies 618a-618d to accommodate the micro-lens arrays.

With reference to FIG. 6A, each PIC die 618a-618d includes a PIC waveguide array 128a-128d, and each PIC waveguide array 128a-128d includes one or more waveguides. In this example, each PIC waveguide array 128a-128d includes four PIC waveguides. For case of illustration and description, FIG. 6A depicts the minimum number of waveguides in the example integrated circuit component 600 that can provide optical connections between each PIC die pair in the multi-die layered structure 610 and between the substrate and each PIC die in the multi-die layered structure 610. One end of the PIC waveguides is disposed in the exposed front end portions of the PIC dies 618a-618d, as shown in FIG. 6A. An opposite end of the PIC waveguides 128a-128d may be connected to photonic circuitry (not shown) in the PIC dies 618a-618d, as previously discussed with reference to photonic circuitry 122a-122d in PIC dies 118a-118d of component 100.

Each of the PIC dies 618a-618d also includes a micro-lens array 682a, 682b, 682c, and 682d disposed in the exposed front end of the PIC dies 618a, 618b, 618c, and 618d, respectively. A micro-lens array includes a plurality of microlenses. A microlens is a small lens typically having a diameter <1 millimeter, and often as small as 10 micrometers. In this example, the micro-lens arrays 682a-682d are one-dimensional, with each micro-lens array arranged in a row that is substantially parallel to the front end of the PIC die on which the micro-lens is disposed. A waveguide is coupled to a single microlens, but in some scenarios, more than one waveguide may be coupled to the same microlens. In this example, a small mirror may be placed at an approximately 45 degree angle below each microlens in the micro-lens arrays 682a-682d, as shown in FIG. 6B. Because optical signals enter the microlenses from above, mirrors 684a, 684b, 684c, and 684d (shown in FIG. 6B) can direct the signals to turn and travel in the waveguides 128a-128d that are substantially parallel to the upper surfaces of the PIC dies 682a-682d. In this example, the substrate waveguide array 106 may be configured with any number of waveguides, but is depicted with four substrate waveguides 150, 154, 157, and 159. Each substrate waveguide can be connected to a respective PIC die 682a-682d by at least one PIC waveguide.

FIG. 6B illustrates the optical coupler 680 and possible waveguides formed therein. FIG. 6C shows a front view of the optical coupler 680. The optical coupler may be produced from a block of glass, ceramic, or other suitable material, including any material that the substrate 102 could be composed of, as previously described herein. In one example, the optical coupler 680 has an inverted stairs shape, with each inverted step including a micro-lens array 686a-686d aligned with one of the micro-lens arrays 682a-682d in the PIC dies 618a-618d. The optical coupler 680 is designed to maintain a spacing between each pair of opposing microlenses when the micro-lens arrays 682a-682d of the PIC dies 618a-618d are aligned with respective micro-lens arrays 686a-686d of the optical coupler 680. The spacing is sufficient to allow collimated light to flow between each pair of opposing microlenses.

The optical coupler 680 includes one or more three-dimensional waveguides 690 formed through the block, with each optical coupler waveguide extending from one microlens of one of the microlens arrays 686a-686d to one waveguide in the substrate waveguide array 106 or to one microlens in another one of the microlens arrays 686a-686d. For example, an optical coupler waveguide can extend from one microlens in the microlens array 686a to one waveguide in the substrate waveguide array 106 to connect the first (bottom) PIC die 618a to the substrate waveguide. Another waveguide in the optical coupler 680 can extend from another microlens in the micro-lens array 686a to a microlens in the micro-lens array 686b to couple the first PIC die 618a to the second PIC die 618b, to a microlens in the micro-lens array 686c to couple the first PIC die 618a to the third PIC die 618c, or to a microlens in the micro-lens array 686d to couple the first PIC die 618a to the fourth (top) PIC die 618d. The optical block illustrated in FIG. 6B depicts waveguides to connect each of the PIC dies 618a-618d to the substrate waveguide array 106 and each of the PIC dies 618a-618d to one other PIC die in the multi-die layered structure 610. It should be apparent that the optical coupler 680 could include additional waveguides to allow each PIC die 618a-618d to be connected to every other PIC die in the multi-die layered structure 610. One or more, or many waveguides may be formed in the optical coupler 680 to connect the PIC dies 618a-618d to each other and to the substrate. Furthermore, in some scenarios, a particular PIC die may not be optically connected to another PIC die and/or to the substrate and thus, the optical coupler 680 may not provide a waveguide for the connection.

The three-dimensional waveguides 690 in the optical coupler 680 serve as intermediate waveguides with one end coupled to a microlens of a micro-lens array aligned with a corresponding micro-lens array in one of the PIC dies 618a-618d, and an opposite end coupled to a substrate waveguide in the substrate waveguide array 106. The coupling of an intermediate waveguide in an optical coupler 680 to a substrate waveguide at a connection point 126 may be achieved using an evanescent mode of coupling as previously described herein with reference to integrated circuit component 100. Any other suitable low-loss optical coupling mechanism to transfer light from one waveguide to another waveguide may be used instead.

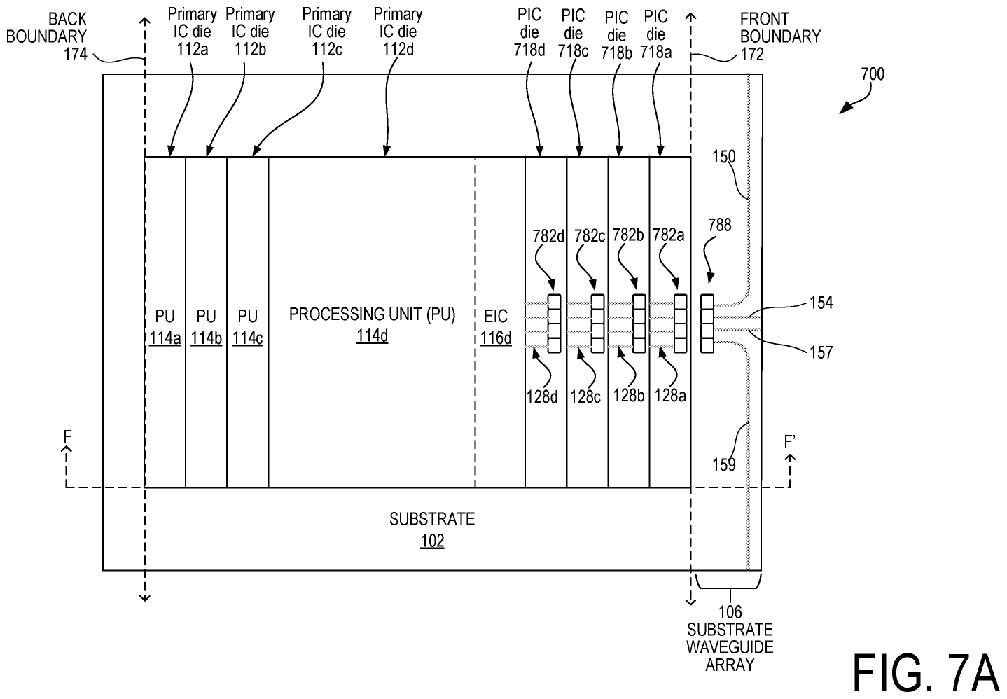

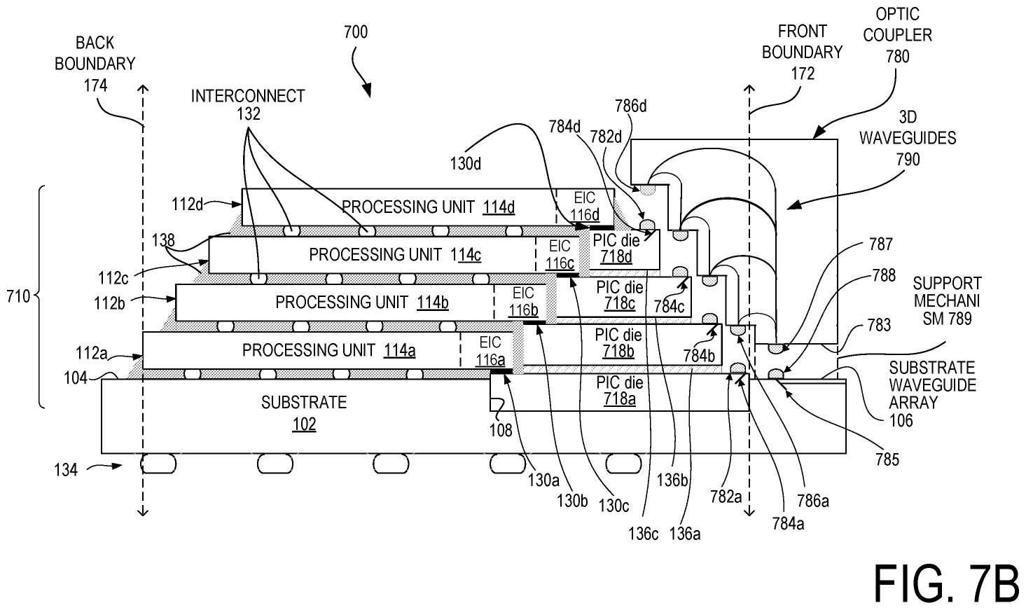

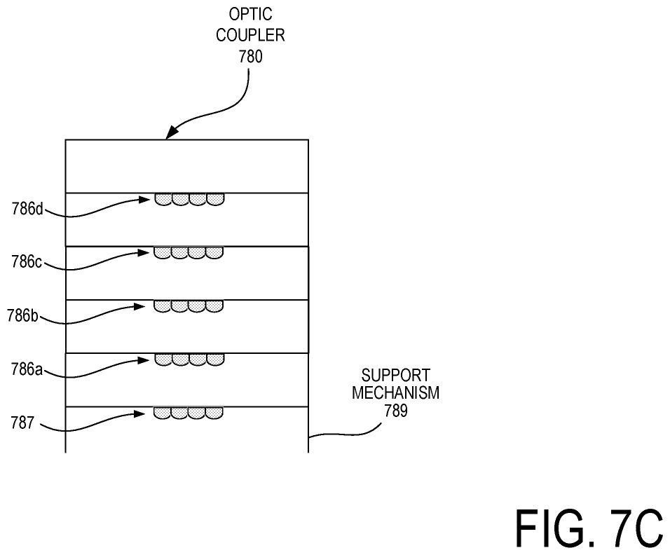

FIG. 7A is a top plan view of a sixth example integrated circuit component 700 and FIG. 7B is a cross-sectional view of component 700 taken along line F-F′ of FIG. 7A. FIG. 7B includes the addition of an optical coupler 780. The integrated circuit component 700 includes a sixth example multi-die layered structure 710. The component 700 is similar to the integrated circuit component 100 (with similar parts having the same reference numbers as FIGS. 1A-1D and 2A-2M) but includes an optical coupler 780 using micro-lens arrays to connect to the PIC waveguides in PIC dies 718a, 718b, 718c, and 718d and to the substrate. The multi-die layered structure 710 is similar to the multi-die layered structure 110 of component 100, with variations in the PIC dies 718a-718d to accommodate the micro-lens arrays 782a, 782b, 782c, and 782d and corresponding mirrors 784a, 784b, 784c, and 784d. A mirror can be provided for each microlens in the microlens arrays 782a-782d.

The integrated circuit component 700 is similar to the integrated circuit component 600, but includes an alternative coupling mechanism between the optical coupler 780 and the substrate waveguides in the substrate waveguide array 106. As shown in FIGS. 7A and 7B, a micro-lens array 788 is provisioned on the substrate and is coupled to the substrate waveguides. In this example, the micro-lens array 788 is configured as a one-dimensional row including four microlenses. In this example, a small mirror may be placed at an approximately 45 degree angle below each microlens in the micro-lens arrays 788, as shown in FIG. 7B. Because optical signals enter the microlenses from above, mirrors 785 can direct outgoing signals from the optical coupler 780 to turn and travel in the substrate waveguides. For incoming signals from received through the substrate waveguides, the mirrors 785 can direct the signals to turn and travel in the waveguides 790 of the optical coupler 780 to the designated PIC dies.

The optical coupler 780 may be designed in a similar inverted stairsteps shape as the optical coupler 680 of component 600. In addition to micro-lens arrays 786a-786d on the stairsteps of the optical coupler 780 that are aligned with micro-lens arrays 782a-782d in the PIC dies 718a-718d, the optical coupler 780 includes another micro-lens array 787 on a lower surface 783 to connect the optical coupler waveguides to the substrate waveguides in the substrate waveguide array 106. Optical coupler 780 is designed to maintain a spacing between each pair of opposing microlenses when the micro-lens array 787 in the optical coupler 780 is aligned with the micro-lens array 788 in the substrate 102. The spacing is sufficient to allow collimated light to flow between each pair of opposing microlenses. In one example, a support mechanism 789 extends between the lower surface 783 of the optical coupler 780 and the upper surface 104 of the substrate 102 to maintain the spacing between the micro-lens arrays (e.g., between 787 and 788, 782a and 786a, 782b and 786b, 782c and 786c, 782d and 786d). FIG. 7C illustrates a front view of the optical coupler 780, showing the additional micro-lens array 787 that couples to the substrate waveguide array.

In FIGS. 1A-1D, 3A-3B, 4A-4B, 5A-5B, 6A-6C, and 7A-7C, a first (bottom) PIC die (e.g., 118a, 318a, 418a, 518a, 618, 718a) of the respective multi-die layered structures is located in the recess 108 in the upper surface 104 of the substrate 102. In the multi-die layered structures, each PIC die is attached to a respective EIC (or a primary integrated circuit die if the EIC is separate) by conductive contacts on the upper surfaces of the PIC dies being attached to conductive contacts on the lower surfaces of the EICs (or primary integrated circuit die if the EIC is separate), for example, solder balls or other suitable attachment. A PIC die embedded in a recess in the surface of the integrated circuit component substrate can be referred to as open-cavity PIC (OCPIC). In other examples, the bottom layer PIC die (e.g., 118a, 318a, 418a, 518a, 618a, 718a) can be partially embedded in the upper surface of the integrated circuit component substrate.

In other examples, the bottom layer PIC die can be located on the same surface of a component substrate as the EIC and other integrated circuit components. For example, the PIC die 118a could be located on the upper surface 104 of the substrate, along with the EIC 116a, the main processing unit 114a, and any chiplets that are included. In such embodiments, a bridge or interposer embedded in the substrate 102 can carry signals between the PIC die 118a and the EIC 116a. Such a bridge or interposer could be embedded in the component substrate (either fully embedded or with an upper surface exposed). Bridges or interposers can be used to carry signals between other components of the integrated circuit component 100, such as between the EIC and the main processing circuit, a chiplet and the main processing circuit, between chiplets, etc. A bridge or interposer can comprise silicon and one or more layers of conductive traces to carry signals between integrated circuit component components. Conductive traces on different layers can be connected by vias and conductive traces on a top surface of the bridge or interposer can connect to an integrated circuit component via direct attachment (e.g., via a solder ball or other conductive contact) if the upper surface of the bridge or interposer is not embedded in the substrate, or by a via that extends from a conductive contact on the upper surface of the bridge or interposer to a conductive contact on the top of the component substrate and to which a conductive contact of the integrated circuit component can attach (by, for example, solder balls). In some embodiments, a bridge or interposer can be an implementation of Intel® embedded multi-die interconnect bridge (EMIB) technology. Additionally, through silicon vias (TSVs) could be used in the lower layer PIC dies 118a-118c and primary integrated circuit dies 112a-112c to carry signals between the bridges or interposers and the upper layer PIC dies 118b-118d and EICs 116b-116d.

Any of the PICs described or referenced herein (e.g., 118a-118d, 318a-318d, 418a-418d, 518a-518d, 618a-618d, 718a-718d) and any of the substrates described or referenced herein (e.g., 102) can comprise one or more optical components, such as a laser (or another light source), photodetectors, micro-ring resonators (for optical signal encoding and decoding), waveguides, combiners, couplers, gratings, wavelength filters, phase shifters, optical switches, micro-lens arrays, and mirrors. A PIC can comprise a bulk silicon or SOI (silicon-on-insulator) substrate upon which one or more optical components are integrated. In embodiments where the PIC comprises a laser comprising III-V materials, such as a laser comprising InP (indium phosphide), GaSb (gallium antimonide), InP/GaAs (indium phosphide and gallium arsenide), or GeSn (germanium tin), the laser can be fabricated separately from the PIC and integrated with the PIC using flip-chip, epitaxial bonding, micro-transfer printing, or another suitable integration approach.

A waveguide in any of the PICs described or referenced herein (e.g., 118a-118d, 318a-318d. 418a-418d, 518a-518d, 618a-618d, 718a-718d) and in any of the substrates described or referenced herein (e.g., 102) can comprise a core comprising silicon and cladding comprising silicon dioxide (SiO₂) or Silicon Oxynitride (SiON). In other embodiments, the core can comprise silicon or silicon nitride (SiNₓ, e.g., Si₃N₄), and the cladding can comprise silicon dioxide (SiO₂). In yet other embodiments, the waveguide can comprise a multilayer system. In one example, a multilayer waveguide can comprise a layer comprising silicon, a layer comprising silicon nitride (SiNₓ), and a layer comprising germanium. In some embodiments, a PIC comprises one or more electronic integrated circuits or devices, such as a transistor (e.g., a planar or non-planar MOSFET).

Any of the EICs described herein (e.g., 116a-116d, EIC/PIC dies 418a-418d, 516a-516d) can comprise one or more integrated circuits to enable communication and data transfer between the electronic and photonic domains. An EIC can comprise, for example, one or more of the following: transmission driver circuitry (e.g., amplifiers, digital-to-analog converters) to generate electronic signals that are used to drive PIC components, receiver circuitry (e.g., analog-to-digital and digital-to-analog converters, amplifiers including but not limited to transimpedance amplifiers (TIAs)) to receive and process photonic signals (e.g., translating photonic signals to electrical signals), wavelength converters, optical couplers to couple light into and out of the PIC, and power management circuitry that provides power to the PIC and manages PIC power consumption. An input/output (I/O) interface can include any suitable interconnect between the EICs and PIC dies. Some nonlimiting examples of suitable I/O interfaces include The Advanced Interface Bus (AIB) offered by Intel® Corp. to move data from microbumps on one chiplet to microbumps on another adjacent device, Serializer/Deserializer (SerDes) interfaces defined by the Optical Internetworking Forum (OIF) to provide data transmission over a single line or a differential pair in order to minimize the number of I/O pins and interconnects, or Universal Chiplet Interconnect Express (UCIe) 1.0 open specification released Mar. 2, 2022, for a die-to-die interconnect and serial bus between chiplets.

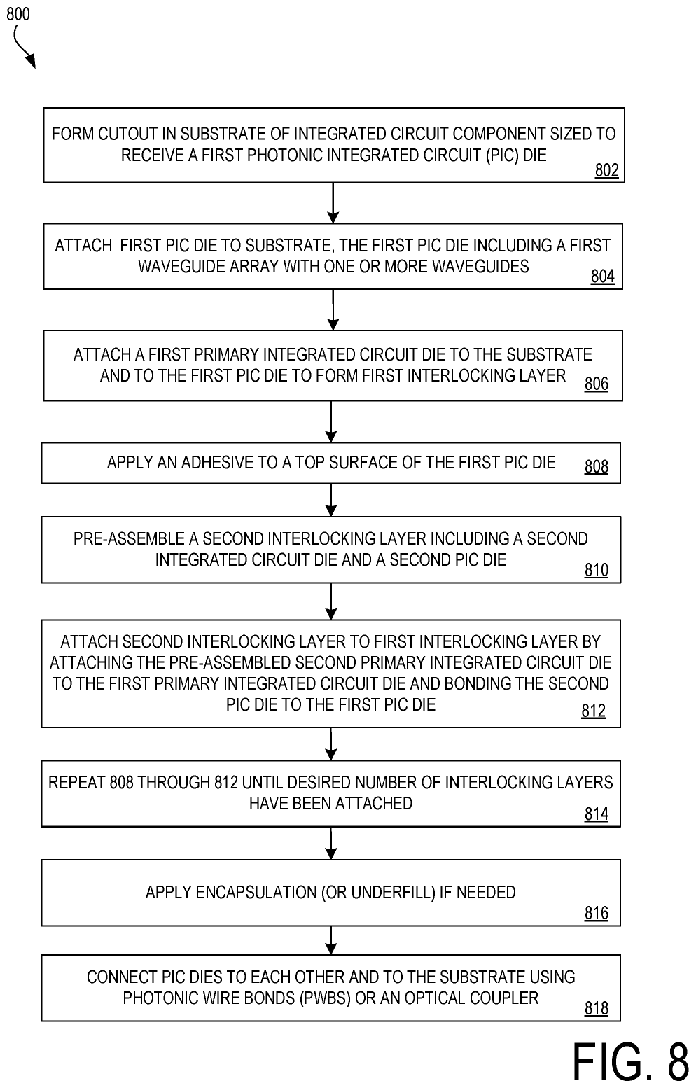

FIG. 8 is an example method of forming an integrated circuit component with a multi-die layered structure. The method can be performed by an integrated circuit component manufacturer. At 802, a cutout is formed in a substrate of an integrated circuit component. At 804, a first photonic integrated circuit (PIC) die is attached to the substrate by, for example, inserting the first PIC into the cutout (e.g., recess). At 806, a first primary integrated circuit, including an electronic integrated circuit (EIC), is attached to the substrate and the first PIC die to form the first interlocking layer.

At 808, an adhesive (e.g., epoxy) is applied to an upper surface of the first PIC die. At 810, pre-assemble a second interlocking layer including a second primary integrated circuit and a second PIC die. At 812, attach the second interlocking layer to the first interlocking layer by attaching the pre-assembled second primary integrated circuit die to the first primary integrated circuit die, and by attaching the second PIC die to the first PIC die. At 814, repeat operations from 808 through 812 for new interlocking layers until a desired number of interlocking layers have formed a multi-die layered structure on the substrate.

At 816, apply encapsulation (e.g., underfill) to the integrated circuit component, if needed. At 818, connect the PIC dies to each other and to the substrate using photonic wire bonds (PWBs) or an optical coupler.

In other embodiments, the method 800 can comprise one or more additional elements. For example, if an electrical integrated circuit (EIC) is not integrated with the primary integrated circuit or with the PIC, then the method 800 can further comprise attaching the EIC to the PIC as part of assembling an interlocking layer.

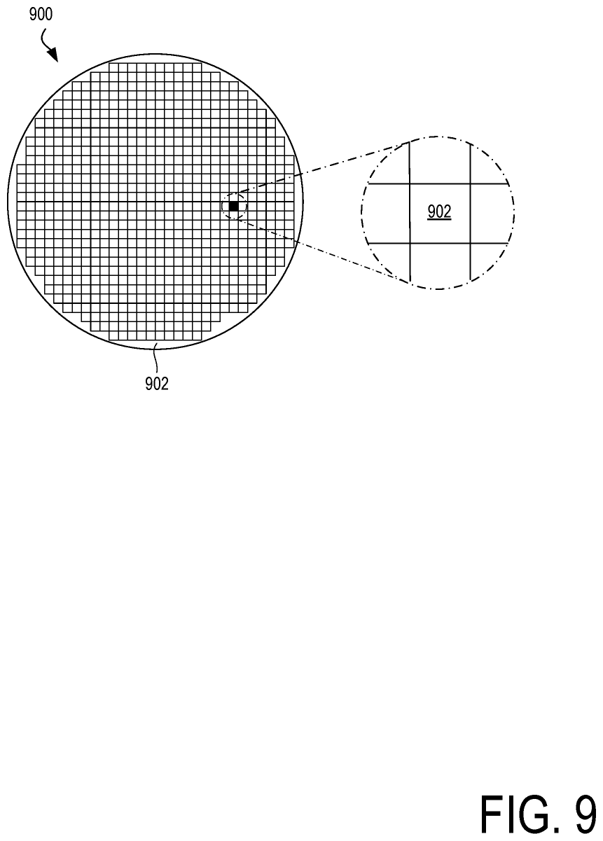

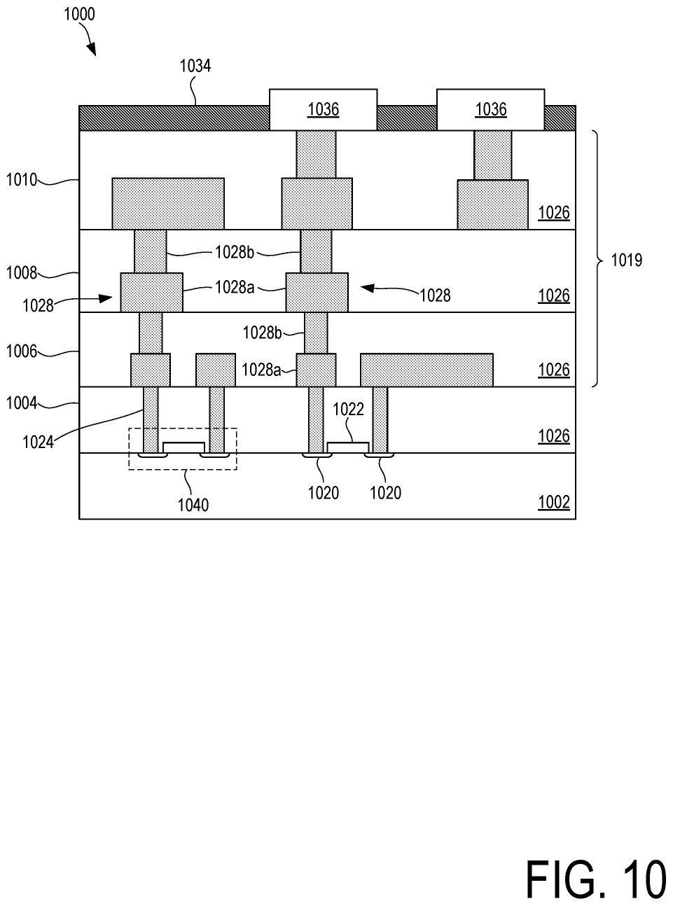

FIG. 9 is a top view of a wafer 900 and dies 902 that may be included in any of the microelectronic assemblies or integrated circuit components (e.g., 100, 300, 400, 500, 600, 700) disclosed herein. The wafer 900 may be composed of semiconductor material and may include one or more dies 902 having integrated circuit structures formed on a surface of the wafer 900. The individual dies 902 may be a repeating unit of an integrated circuit product that includes any suitable integrated circuit. After the fabrication of the semiconductor product is complete, the wafer 900 may undergo a singulation process in which the dies 902 are separated from one another to provide discrete “chips” of the integrated circuit product. The die 902 may be any of the processing units disclosed herein (e.g., 114a-114d). The die 902 may include one or more transistors (e.g., some of the transistors 1040 of FIG. 10, discussed below), supporting circuitry to route electrical signals to the transistors, passive components (e.g., signal traces, resistors, capacitors, or inductors), and/or any other integrated circuit components. In some embodiments, the wafer 900 or the die 902 may include a memory device (e.g., a random access memory (RAM) device, such as a static RAM (SRAM) device, a magnetic RAM (MRAM) device, a resistive RAM (RRAM) device, a conductive-bridging RAM (CBRAM) device, etc.), a logic device (e.g., an AND, OR, NAND, or NOR gate), or any other suitable circuit element. Multiple ones of these devices may be combined on a single die 902. For example, a memory array formed by multiple memory devices may be formed on a same die 902 as a processor unit or other logic that is configured to store information in the memory devices or execute instructions stored in the memory array. Various ones of the microelectronic assemblies disclosed herein may be manufactured using a die-to-wafer assembly technique in which some dies 902 are attached to a wafer 900 that include others of the dies 902, and the wafer 900 is subsequently singulated.

FIG. 10 is a cross-sectional view of an integrated circuit device 1000 that may be included in any of the microelectronic assemblies or integrated circuit components (e.g., 100, 300, 400, 500, 600, 700) disclosed herein (e.g., in any of the dies 902). One or more of the integrated circuit devices 1000 may be included in one or more dies 902 (FIG. 9). The integrated circuit device 1000 may be formed on a die substrate 1002 (e.g., the wafer 900 of FIG. 9) and may be included in a die (e.g., the die 902 of FIG. 9). The die substrate 1002 may be a semiconductor substrate composed of semiconductor material systems including, for example, n-type or p-type materials systems (or a combination of both). The die substrate 1002 may include, for example, a crystalline substrate formed using a bulk silicon or a silicon-on-insulator (SOI) substructure. In some embodiments, the die substrate 1002 may be formed using alternative materials, which may or may not be combined with silicon, that include, but are not limited to, germanium, indium antimonide, lead telluride, indium arsenide, indium phosphide, gallium arsenide, or gallium antimonide. Further materials classified as group II-VI, III-V, or IV may also be used to form the die substrate 1002. Although a few examples of materials from which the die substrate 1002 may be formed are described here, any material that may serve as a foundation for an integrated circuit device 1000 may be used. The die substrate 1002 may be part of a singulated die (e.g., the dies 902 of FIG. 9) or a wafer (e.g., the wafer 900 of FIG. 9).

The integrated circuit device 1000 may include one or more device layers 1004 disposed on the die substrate 1002. The device layer 1004 may include features of one or more transistors 1040 (e.g., metal oxide semiconductor field-effect transistors (MOSFETs)) formed on the die substrate 1002. The transistors 1040 may include, for example, one or more source and/or drain (S/D) regions 1020, a gate 1022 to control current flow between the S/D regions 1020, and one or more S/D contacts 1024 to route electrical signals to/from the S/D regions 1020. The transistors 1040 may include additional features not depicted for the sake of clarity, such as device isolation regions, gate contacts, and the like. The transistors 1040 are not limited to the type and configuration depicted in FIG. 10 and may include a wide variety of other types and configurations such as, for example, planar transistors, non-planar transistors, or a combination of both. Non-planar transistors may include FinFET transistors, such as double-gate transistors or tri-gate transistors, and wrap-around or all-around gate transistors, such as nanoribbon, nanosheet, or nanowire transistors. A transistor 1040 may include a gate 1022 formed of at least two layers, a gate dielectric, and a gate electrode. The gate dielectric may include one layer or a stack of layers. The one or more layers may include silicon oxide, silicon dioxide, silicon carbide, and/or a high-k dielectric material.

The high-k dielectric material may include elements such as hafnium, silicon, oxygen, titanium, tantalum, lanthanum, aluminum, zirconium, barium, strontium, yttrium, lead, scandium, niobium, and zinc. Examples of high-k materials that may be used in the gate dielectric include, but are not limited to, hafnium oxide, hafnium silicon oxide, lanthanum oxide, lanthanum aluminum oxide, zirconium oxide, zirconium silicon oxide, tantalum oxide, titanium oxide, barium strontium titanium oxide, barium titanium oxide, strontium titanium oxide, yttrium oxide, aluminum oxide, lead scandium tantalum oxide, and lead zinc niobate. In some embodiments, an annealing process may be carried out on the gate dielectric to improve its quality when a high-k material is used.

The gate electrode may be formed on the gate dielectric and may include at least one p-type work function metal or n-type work function metal, depending on whether the transistor 1040 is to be a p-type metal oxide semiconductor (PMOS) or an n-type metal oxide semiconductor (NMOS) transistor. In some implementations, the gate electrode may consist of a stack of two or more metal layers, where one or more metal layers are work function metal layers and at least one metal layer is a fill metal layer. Further metal layers may be included for other purposes, such as a barrier layer.

For a PMOS transistor, metals that may be used for the gate electrode include, but are not limited to, ruthenium, palladium, platinum, cobalt, nickel, conductive metal oxides (e.g., ruthenium oxide), and any of the metals discussed below with reference to an NMOS transistor (e.g., for work function tuning). For an NMOS transistor, metals that may be used for the gate electrode include, but are not limited to, hafnium, zirconium, titanium, tantalum, aluminum, alloys of these metals, carbides of these metals (e.g., hafnium carbide, zirconium carbide, titanium carbide, tantalum carbide, and aluminum carbide), and any of the metals discussed above with reference to a PMOS transistor (e.g., for work function tuning).

In some embodiments, when viewed as a cross-section of the transistor 1040 along the source-channel-drain direction, the gate electrode may consist of a U-shaped structure that includes a bottom portion substantially parallel to the surface of the die substrate 1002 and two sidewall portions that are substantially perpendicular to the upper surface of the die substrate 1002. In other embodiments, at least one of the metal layers that form the gate electrode may simply be a planar layer that is substantially parallel to the upper surface of the die substrate 1002 and does not include sidewall portions substantially perpendicular to the upper surface of the die substrate 1002. In other embodiments, the gate electrode may consist of a combination of U-shaped structures and planar, non-U-shaped structures. For example, the gate electrode may consist of one or more U-shaped metal layers formed atop one or more planar, non-U-shaped layers.

In some embodiments, a pair of sidewall spacers may be formed on opposing sides of the gate stack to bracket the gate stack. The sidewall spacers may be formed from materials such as silicon nitride, silicon oxide, silicon carbide, silicon nitride doped with carbon, and silicon oxynitride. Processes for forming sidewall spacers are well known in the art and generally include deposition and etching process steps. In some embodiments, a plurality of spacer pairs may be used; for instance, two pairs, three pairs, or four pairs of sidewall spacers may be formed on opposing sides of the gate stack.

The S/D regions 1020 may be formed within the die substrate 1002 adjacent to the gate 1022 of individual transistors 1040. The S/D regions 1020 may be formed using an implantation/diffusion process or an etching/deposition process, for example. In the former process, dopants such as boron, aluminum, antimony, phosphorous, or arsenic may be ion-implanted into the die substrate 1002 to form the S/D regions 1020. An annealing process that activates the dopants and causes them to diffuse farther into the die substrate 1002 may follow the ion-implantation process. In the latter process, the die substrate 1002 may first be etched to form recesses at the locations of the S/D regions 1020. An epitaxial deposition process may then be carried out to fill the recesses with material that is used to fabricate the S/D regions 1020. In some implementations, the S/D regions 1020 may be fabricated using a silicon alloy such as silicon germanium or silicon carbide. In some embodiments, the epitaxially deposited silicon alloy may be doped in situ with dopants such as boron, arsenic, or phosphorous. In some embodiments, the S/D regions 1020 may be formed using one or more alternate semiconductor materials such as germanium or a group III-V material or alloy. In further embodiments, one or more layers of metal and/or metal alloys may be used to form the S/D regions 1020.

Electrical signals, such as power and/or input/output (I/O) signals, may be routed to and/or from the devices (e.g., transistors 1040) of the device layer 1004 through one or more interconnect layers disposed on the device layer 1004 (illustrated in FIG. 10 as interconnect layers 1006-1010). For example, electrically conductive features of the device layer 1004 (e.g., the gate 1022 and the S/D contacts 1024) may be electrically coupled with the interconnect structures 1028 of the interconnect layers 1006-1010. The one or more interconnect layers 1006-1010 may form a metallization stack (also referred to as an “ILD stack”) 10110 of the integrated circuit device 1000.

The interconnect structures 1028 may be arranged within the interconnect layers 1006-1010 to route electrical signals according to a wide variety of designs; in particular, the arrangement is not limited to the particular configuration of interconnect structures 1028 depicted in FIG. 10. Although a particular number of interconnect layers 1006-1010 is depicted in FIG. 10, embodiments of the present disclosure include integrated circuit devices having more or fewer interconnect layers than depicted.

In some embodiments, the interconnect structures 1028 may include lines 1028a and/or vias 1028b filled with an electrically conductive material such as a metal. The lines 1028a may be arranged to route electrical signals in a direction of a plane that is substantially parallel with a surface of the die substrate 1002 upon which the device layer 1004 is formed. For example, the lines 1028a may route electrical signals in a direction in and out of the page and/or in a direction across the page from the perspective of FIG. 10. The vias 1028b may be arranged to route electrical signals in a direction of a plane that is substantially perpendicular to the surface of the die substrate 1002 upon which the device layer 1004 is formed. In some embodiments, the vias 1028b may electrically couple lines 1028a of different interconnect layers 1006-1010 together.

The interconnect layers 1006-1010 may include a dielectric material 1026 disposed between the interconnect structures 1028, as shown in FIG. 10. In some embodiments, dielectric material 1026 disposed between the interconnect structures 1028 in different ones of the interconnect layers 1006-1010 may have different compositions; in other embodiments, the composition of the dielectric material 1026 between different interconnect layers 1006-1010 may be the same. The device layer 1004 may include a dielectric material 1026 disposed between the transistors 1040 and a bottom layer of the metallization stack as well. The dielectric material 1026 included in the device layer 1004 may have a different composition than the dielectric material 1026 included in the interconnect layers 1006-1010; in other embodiments, the composition of the dielectric material 1026 in the device layer 1004 may be the same as a dielectric material 1026 included in any one of the interconnect layers 1006-1010.

A first interconnect layer 1006 (referred to as Metal 1 or “M1”) may be formed directly on the device layer 1004. In some embodiments, the first interconnect layer 1006 may include lines 1028a and/or vias 1028b, as shown. The lines 1028a of the first interconnect layer 1006 may be coupled with contacts (e.g., the S/D contacts 1024) of the device layer 1004. The vias 1028b of the first interconnect layer 1006 may be coupled with the lines 1028a of a second interconnect layer 1008.

The second interconnect layer 1008 (referred to as Metal 2 or “M2”) may be formed directly on the first interconnect layer 1006. In some embodiments, the second interconnect layer 1008 may include via 1028b to couple the lines 1028 of the second interconnect layer 1008 with the lines 1028a of a third interconnect layer 1010. Although the lines 1028a and the vias 1028b are structurally delineated with a line within individual interconnect layers for the sake of clarity, the lines 1028a and the vias 1028b may be structurally and/or materially contiguous (e.g., simultaneously filled during a dual-damascene process) in some embodiments.

The third interconnect layer 1010 (referred to as Metal 3 or “M3”) (and additional interconnect layers, as desired) may be formed in succession on the second interconnect layer 1008 according to similar techniques and configurations described in connection with the second interconnect layer 1008 or the first interconnect layer 1006. In some embodiments, the interconnect layers that are “higher up” in the metallization stack 1019 in the integrated circuit device 1000 (i.e., farther away from the device layer 1004) may be thicker that the interconnect layers that are lower in the metallization stack 1019, with lines 1028a and vias 1028b in the higher interconnect layers being thicker than those in the lower interconnect layers.

The integrated circuit device 1000 may include a solder resist material 1034 (e.g., polyimide or similar material) and one or more conductive contacts 1036 formed on the interconnect layers 1006-1010. In FIG. 10, the conductive contacts 1036 are illustrated as taking the form of bond pads. The conductive contacts 1036 may be electrically coupled with the interconnect structures 1028 and configured to route the electrical signals of the transistor(s) 1040 to external devices. For example, solder bonds may be formed on the one or more conductive contacts 1036 to mechanically and/or electrically couple an integrated circuit die including the integrated circuit device 1000 with another component (e.g., a printed circuit board). The integrated circuit device 1000 may include additional or alternate structures to route the electrical signals from the interconnect layers 1006-1010; for example, the conductive contacts 1036 may include other analogous features (e.g., posts) that route the electrical signals to external components.

In some embodiments in which the integrated circuit device 1000 is a double-sided die, the integrated circuit device 1000 may include another metallization stack (not shown) on the opposite side of the device layer(s) 1004. This metallization stack may include multiple interconnect layers as discussed above with reference to the interconnect layers 1006-1010, to provide conductive pathways (e.g., including conductive lines and vias) between the device layer(s) 1004 and additional conductive contacts (not shown) on the opposite side of the integrated circuit device 1000 from the conductive contacts 1036.

In other embodiments in which the integrated circuit device 1000 is a double-sided die, the integrated circuit device 1000 may include one or more through silicon vias (TSVs) through the die substrate 1002; these TSVs may make contact with the device layer(s) 1004, and may provide conductive pathways between the device layer(s) 1004 and additional conductive contacts (not shown) on the opposite side of the integrated circuit device 1000 from the conductive contacts 1036. In some embodiments, TSVs extending through the substrate can be used for routing power and ground signals from conductive contacts on the opposite side of the integrated circuit device 1000 from the conductive contacts 1036 to the transistors 1040 and any other components integrated into the die 1000, and the metallization stack 1019 can be used to route I/O signals from the conductive contacts 1036 to transistors 1040 and any other components integrated into the die 1000.

Multiple integrated circuit devices 1000 may be stacked with one or more TSVs in the individual stacked devices providing connection between one of the devices to any of the other devices in the stack. For example, one or more high-bandwidth memory (HBM) integrated circuit dies can be stacked on top of a base integrated circuit die and TSVs in the HBM dies can provide connection between the individual HBM and the base integrated circuit die. Conductive contacts can provide additional connections between adjacent integrated circuit dies in the stack. In some embodiments, the conductive contacts can be fine-pitch solder bumps (microbumps).

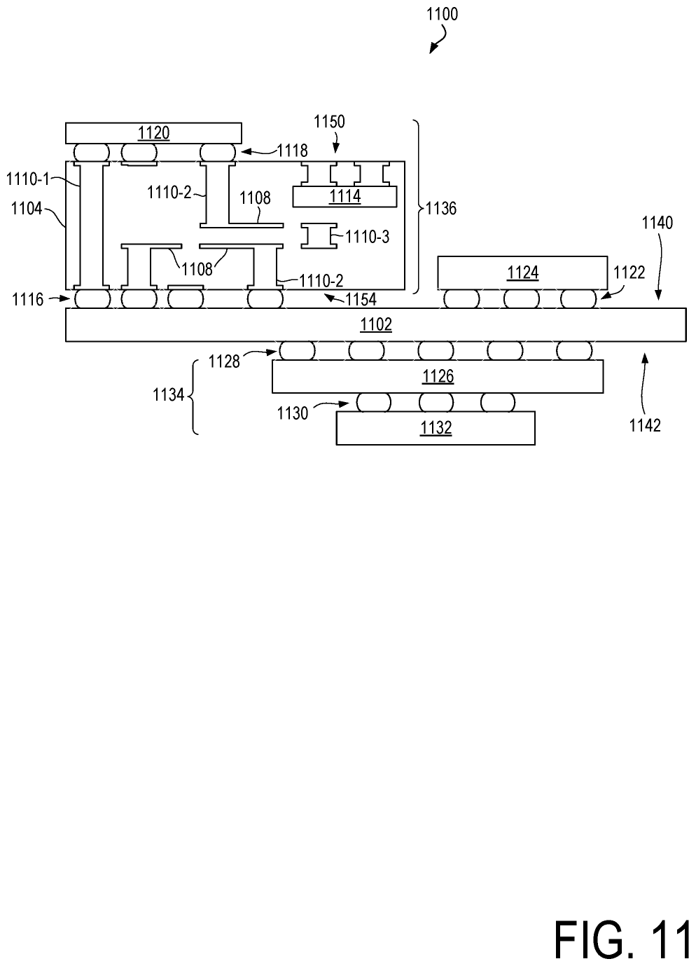

FIG. 11 is a cross-sectional side of an integrated circuit device assembly 1100 that may include any of the microelectronic assemblies or integrated circuit components (e.g., 100, 300, 400, 500, 600, 700) disclosed herein. The integrated circuit device assembly 1100 includes a number of components disposed on a circuit board 1102 (which may be a motherboard, system board, mainboard, etc.). The integrated circuit device assembly 1100 includes components disposed on a first face 1140 of the circuit board 1102 and an opposing second face 1142 of the circuit board 1102; generally, components may be disposed on one or both faces 1140 and 1142. Any of the integrated circuit components discussed below with reference to the integrated circuit device assembly 1100 may take the form of any suitable ones of the embodiments of the microelectronic assemblies disclosed herein.

In some embodiments, the circuit board 1102 may be a printed circuit board (PCB) including multiple metal (or interconnect) layers separated from one another by layers of dielectric material and interconnected by electrically conductive vias. The individual metal layers comprise conductive traces. Any one or more of the metal layers may be formed in a desired circuit pattern to route electrical signals (optionally in conjunction with other metal layers) between the components coupled to the circuit board 1102. In other embodiments, the circuit board 1102 may be a non-PCB substrate. In some embodiments the circuit board 1102 may be, for example, an integrated circuit component substrate (e.g., 102) or a circuit board 1102 to which a socket is attached. The integrated circuit device assembly 1100 illustrated in FIG. 11 includes a package-on-interposer structure 1136 coupled to the first face 1140 of the circuit board 1102 by coupling components 1116. The coupling components 1116 may electrically and mechanically couple the package-on-interposer structure 1136 to the circuit board 1102, and may include solder balls (as shown in FIG. 11), pins (e.g., as part of a pin grid array (PGA), contacts (e.g., as part of a land grid array (LGA)), male and female portions of a socket, an adhesive, an underfill material, and/or any other suitable electrical and/or mechanical coupling structure. The coupling components 1116 may serve as the coupling components illustrated or described for any of the substrate assembly or substrate assembly components described herein, as appropriate.

The package-on-interposer structure 1136 may include an integrated circuit component 1120 coupled to an interposer 1104 by coupling components 1118. The coupling components 1118 may take any suitable form for the application, such as the forms discussed above with reference to the coupling components 1116. Although a single integrated circuit component 1120 is shown in FIG. 11, multiple integrated circuit components may be coupled to the interposer 1104; indeed, additional interposers may be coupled to the interposer 1104. The interposer 1104 may provide an intervening substrate used to bridge the circuit board 1102 and the integrated circuit component 1120.

The integrated circuit component 1120 may be a packaged or unpacked integrated circuit product that includes one or more integrated circuit dies (e.g., the die 902 of FIG. 9, the integrated circuit device 1000 of FIG. 10) and/or one or more other suitable components. A packaged integrated circuit component comprises one or more integrated circuit dies mounted on a component substrate with the integrated circuit dies and component substrate encapsulated in a casing material, such as a metal, plastic, glass, or ceramic. In one example of an unpackaged integrated circuit component 1120, a single monolithic integrated circuit die comprises solder bumps attached to contacts on the die. The solder bumps allow the die to be directly attached to the interposer 1104. The integrated circuit component 1120 can comprise one or more computing system components, such as one or more processor units (e.g., system-on-a-chip (SoC), processor core, graphics processor unit (GPU), accelerator, chipset processor), I/O controller, memory, or network interface controller. In some embodiments, the integrated circuit component 1120 can comprise one or more additional active or passive devices such as capacitors, decoupling capacitors, resistors, inductors, fuses, diodes, transformers, sensors, electrostatic discharge (ESD) devices, and memory devices.

In embodiments where the integrated circuit component 1120 comprises multiple integrated circuit dies, the dies can be of the same type (a homogeneous multi-die integrated circuit component) or of two or more different types (a heterogeneous multi-die integrated circuit component). A multi-die integrated circuit component can be referred to as a multi-chip package (MCP) or multi-chip module (MCM).

In addition to comprising one or more processor units, the integrated circuit component 1120 can comprise additional components, such as embedded DRAM, stacked high bandwidth memory (HBM), shared cache memories, input/output (I/O) controllers, or memory controllers. Any of these additional components can be located on the same integrated circuit die as a processor unit, or on one or more integrated circuit dies separate from the integrated circuit dies comprising the processor units. These separate integrated circuit dies can be referred to as “chiplets”. In embodiments where an integrated circuit component comprises multiple integrated circuit dies, the integrated circuit dies can be conductively coupled by one or more conductive traces (and vias between the conductive traces if the conductive traces are on multiple layers and/or if the conductive traces are embedded in the substrate, bridge, or interposer) of the component substrate, one or more silicon interposers, one or more silicon bridges embedded in the component substrate, or combinations thereof.

Generally, the interposer 1104 may spread connections to a wider pitch or reroute a connection to a different connection. For example, the interposer 1104 may couple the integrated circuit component 1120 to a set of ball grid array (BGA) conductive contacts of the coupling components 1116 for coupling to the circuit board 1102. In the embodiment illustrated in FIG. 11, the integrated circuit component 1120 and the circuit board 1102 are attached to opposing sides of the interposer 1104; in other embodiments, the integrated circuit component 1120 and the circuit board 1102 may be attached to a same side of the interposer 1104. In some embodiments, three or more components may be interconnected by way of the interposer 1104.

In some embodiments, the interposer 1104 may be formed as a PCB, including multiple metal layers separated from one another by layers of dielectric material and interconnected by electrically conductive vias. In some embodiments, the interposer 1104 may be formed of an epoxy resin, a fiberglass-reinforced epoxy resin, an epoxy resin with inorganic fillers, a ceramic material, or a polymer material such as polyimide. In some embodiments, the interposer 1104 may be formed of alternate rigid or flexible materials that may include the same materials described above for use in a semiconductor substrate, such as silicon, germanium, and other group III-V and group IV materials. The interposer 1104 may include metal interconnects 1108 and vias 1110, including but not limited to through hole vias 1110-1 (that extend from a first face 1150 of the interposer 1104 to a second face 1154 of the interposer 1104), blind vias 1110-2 (that extend from the first or second faces 1150 or 1154 of the interposer 1104 to an internal metal layer), and buried vias 1110-3 (that connect internal metal layers).

In some embodiments, the interposer 1104 can comprise a silicon interposer. Through silicon vias (TSV) extending through the silicon interposer can connect connections on a first face of a silicon interposer to an opposing second face of the silicon interposer. In some embodiments, an interposer 1104 comprising a silicon interposer can further comprise one or more routing layers to route connections on a first face of the interposer 1104 to an opposing second face of the interposer 1104.

The interposer 1104 may further include embedded devices 1114, including both passive and active devices. Such devices may include, but are not limited to, capacitors, decoupling capacitors, resistors, inductors, fuses, diodes, transformers, sensors, electrostatic discharge (ESD) devices, and memory devices. More complex devices such as radio frequency devices, power amplifiers, power management devices, antennas, arrays, sensors, and microelectromechanical systems (MEMS) devices may also be formed on the interposer 1104. The package-on-interposer structure 1136 may take the form of any of the package-on-interposer structures known in the art. In embodiments where the interposer is a non-printed circuit board

The integrated circuit device assembly 1100 may include an integrated circuit component 1124 coupled to the first face 1140 of the circuit board 1102 by coupling components 1122. The coupling components 1122 may take the form of any of the embodiments discussed above with reference to the coupling components 1116, and the integrated circuit component 1124 may take the form of any of the embodiments discussed above with reference to the integrated circuit component 1120.

The integrated circuit device assembly 1100 illustrated in FIG. 11 includes a package-on-package structure 1134 coupled to the second face 1142 of the circuit board 1102 by coupling components 1128. The package-on-package structure 1134 may include an integrated circuit component 1126 and an integrated circuit component 1132 coupled together by coupling components 1130 such that the integrated circuit component 1126 is disposed between the circuit board 1102 and the integrated circuit component 1132. The coupling components 1128 and 1130 may take the form of any of the embodiments of the coupling components 1116 discussed above, and the integrated circuit components 1126 and 1132 may take the form of any of the embodiments of the integrated circuit component 1120 discussed above. The package-on-package structure 1134 may be configured in accordance with any of the package-on-package structures known in the art.

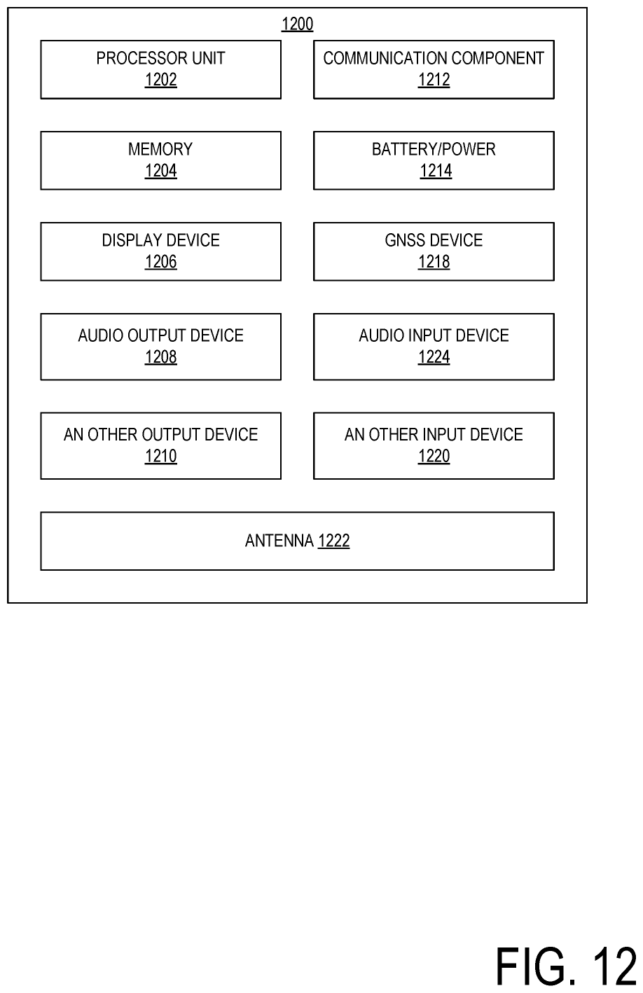

FIG. 12 is a block diagram of an example electrical device 1200 that may include one or more of the microelectronic assemblies or integrated circuit components (e.g., 100, 300, 400, 500, 600, 700) disclosed herein. For example, any suitable ones of the components of the electrical device 1200 may include one or more of the integrated circuit device assemblies, integrated circuit components, integrated circuit devices, or integrated circuit dies disclosed herein, and may be arranged in any of the microelectronic assemblies disclosed herein. A number of components are illustrated in FIG. 12 as included in the electrical device 1200, but any one or more of these components may be omitted or duplicated, as suitable for the application. In some embodiments, some or all of the components included in the electrical device 1200 may be attached to one or more motherboards mainboards, or system boards. In some embodiments, one or more of these components are fabricated onto a single system-on-a-chip (SoC) die.

Additionally, in various embodiments, the electrical device 1200 may not include one or more of the components illustrated in FIG. 12, but the electrical device 1200 may include interface circuitry for coupling to the one or more components. For example, the electrical device 1200 may not include a display device 1206, but may include display device interface circuitry (e.g., a connector and driver circuitry) to which a display device 1206 may be coupled. In another set of examples, the electrical device 1200 may not include an audio input device 1224 or an audio output device 1208, but may include audio input or output device interface circuitry (e.g., connectors and supporting circuitry) to which an audio input device 1224 or audio output device 1208 may be coupled.

The electrical device 1200 may include one or more processor units 1202 (e.g., one or more processor units). As used herein, the terms “processor unit”, “processing unit” or “processor” may refer to any device or portion of a device that processes electronic data from registers and/or memory to transform that electronic data into other electronic data that may be stored in registers and/or memory. The processor unit 1202 may include one or more digital signal processors (DSPs), application-specific integrated circuits (ASICs), central processing units (CPUs), graphics processing units (GPUs), general-purpose GPUs (GPGPUs), accelerated processing units (APUs), field-programmable gate arrays (FPGAs), neural network processing units (NPUs), data processor units (DPUs), accelerators (e.g., graphics accelerator, compression accelerator, artificial intelligence accelerator), controller cryptoprocessors (specialized processors that execute cryptographic algorithms within hardware), server processors, controllers, or any other suitable type of processor units. As such, the processor unit can be referred to as an XPU (or xPU).

The electrical device 1200 may include a memory 1204, which may itself include one or more memory devices such as volatile memory (e.g., dynamic random-access memory (DRAM), static random-access memory (SRAM)), non-volatile memory (e.g., read-only memory (ROM), flash memory, chalcogenide-based phase-change non-voltage memories), solid state memory, and/or a hard drive. In some embodiments, the memory 1204 may include memory that is located on the same integrated circuit die as the processor unit 1202. This memory may be used as cache memory (e.g., Level 1 (L1), Level 2 (L2), Level 3 (L3), Level 4 (L4), Last Level Cache (LLC)) and may include embedded dynamic random-access memory (eDRAM) or spin transfer torque magnetic random-access memory (STT-MRAM).

In some embodiments, the electrical device 1200 can comprise one or more processor units 1202 that are heterogeneous or asymmetric to another processor unit 1202 in the electrical device 1200. There can be a variety of differences between the processing units 1202 in a system in terms of a spectrum of metrics of merit including architectural, microarchitectural, thermal, power consumption characteristics, and the like. These differences can effectively manifest themselves as asymmetry and heterogeneity among the processor units 1202 in the electrical device 1200.

In some embodiments, the electrical device 1200 may include a communication component 1212 (e.g., one or more communication components). For example, the communication component 1212 can manage wireless communications for the transfer of data to and from the electrical device 1200. The term “wireless” and its derivatives may be used to describe circuits, devices, systems, methods, techniques, communications channels, etc., that may communicate data through the use of modulated electromagnetic radiation through a nonsolid medium. The term “wireless” does not imply that the associated devices do not contain any wires, although in some embodiments they might not.

The communication component 1212 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra mobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication component 1212 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication component 1212 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication component 1212 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication component 1212 may operate in accordance with other wireless protocols in other embodiments. The electrical device 1200 may include an antenna 1222 to facilitate wireless communications and/or to receive other wireless communications (such as AM or FM radio transmissions).

In some embodiments, the communication component 1212 may manage wired communications, such as electrical, optical, or any other suitable communication protocols (e.g., IEEE 802.3 Ethernet standards). As noted above, the communication component 1212 may include multiple communication components. For instance, a first communication component 1212 may be dedicated to shorter-range wireless communications such as Wi-Fi or Bluetooth, and a second communication component 1212 may be dedicated to longer-range wireless communications such as global positioning system (GPS), EDGE, GPRS, CDMA, WiMAX, LTE, EV-DO, or others. In some embodiments, a first communication component 1212 may be dedicated to wireless communications, and a second communication component 1212 may be dedicated to wired communications.

The electrical device 1200 may include battery/power circuitry 1214. The battery/power circuitry 1214 may include one or more energy storage devices (e.g., batteries or capacitors) and/or circuitry for coupling components of the electrical device 1200 to an energy source separate from the electrical device 1200 (e.g., AC line power).

The electrical device 1200 may include a display device 1206 (or corresponding interface circuitry, as discussed above). The display device 1206 may include one or more embedded or wired or wirelessly connected external visual indicators, such as a heads-up display, a computer monitor, a projector, a touchscreen display, a liquid crystal display (LCD), a light-emitting diode display, or a flat panel display.

The electrical device 1200 may include an audio output device 1208 (or corresponding interface circuitry, as discussed above). The audio output device 1208 may include any embedded or wired or wirelessly connected external device that generates an audible indicator, such speakers, headsets, or earbuds.

The electrical device 1200 may include an audio input device 1224 (or corresponding interface circuitry, as discussed above). The audio input device 1224 may include any embedded or wired or wirelessly connected device that generates a signal representative of a sound, such as microphones, microphone arrays, or digital instruments (e.g., instruments having a musical instrument digital interface (MIDI) output). The electrical device 1200 may include a Global Navigation Satellite System (GNSS) device 1218 (or corresponding interface circuitry, as discussed above), such as a Global Positioning System (GPS) device. The GNSS device 1218 may be in communication with a satellite-based system and may determine a geolocation of the electrical device 1200 based on information received from one or more GNSS satellites, as known in the art.

The electrical device 1200 may include an other output device 1210 (or corresponding interface circuitry, as discussed above). Examples of the other output device 1210 may include an audio codec, a video codec, a printer, a wired or wireless transmitter for providing information to other devices, or an additional storage device.

The electrical device 1200 may include an other input device 1220 (or corresponding interface circuitry, as discussed above). Examples of the other input device 1220 may include an accelerometer, a gyroscope, a compass, an image capture device (e.g., monoscopic or stereoscopic camera), a trackball, a trackpad, a touchpad, a keyboard, a cursor control device such as a mouse, a stylus, a touchscreen, proximity sensor, microphone, a bar code reader, a Quick Response (QR) code reader, electrocardiogram (ECG) sensor, PPG (photoplethysmogram) sensor, galvanic skin response sensor, any other sensor, or a radio frequency identification (RFID) reader.

The electrical device 1200 may have any desired form factor, such as a hand-held or mobile electrical device (e.g., a cell phone, a smart phone, a mobile internet device, a music player, a tablet computer, a laptop computer, a 2-in-1 convertible computer, a portable all-in-one computer, a netbook computer, an ultrabook computer, a personal digital assistant (PDA), an ultra mobile personal computer, a portable gaming console, etc.), a desktop electrical device, a server, a rack-level computing solution (e.g., blade, tray or sled computing systems), a workstation or other networked computing component, a printer, a scanner, a monitor, a set-top box, an entertainment control unit, a stationary gaming console, smart television, a vehicle control unit, a digital camera, a digital video recorder, a wearable electrical device or an embedded computing system (e.g., computing systems that are part of a vehicle, smart home appliance, consumer electronics product or equipment, manufacturing equipment). In some embodiments, the electrical device 1200 may be any other electronic device that processes data. In some embodiments, the electrical device 1200 may comprise multiple discrete physical components. Given the range of devices that the electrical device 1200 can be manifested as in various embodiments, in some embodiments, the electrical device 1200 can be referred to as a computing device or a computing system.

As used in this application and the claims, a list of items joined by the term “and/or” can mean any combination of the listed items. For example, the phrase “A, B and/or C” can mean A; B; C; A and B; A and C; B and C; or A, B and C. As used in this application and the claims, a list of items joined by the term “at least one of” can mean any combination of the listed terms. For example, the phrase “at least one of A, B or C” can mean A; B; C; A and B; A and C; B and C; or A, B, and C. Moreover, as used in this application and the claims, a list of items joined by the term “one or more of” can mean any combination of the listed terms. For example, the phrase “one or more of A, B and C” can mean A; B; C; A and B; A and C; B and C; or A, B, and C.

As used in this application and the claims, the phrase “individual of” or “respective of” following by a list of items recited or stated as having a trait, feature, etc. means that all of the items in the list possess the stated or recited trait, feature, etc. For example, the phrase “individual of A, B, or C, comprise a sidewall” or “respective of A, B, or C, comprise a sidewall” means that A comprises a sidewall, B comprises sidewall, and C comprises a sidewall.

The disclosed methods, apparatuses, and systems are not to be construed as limiting in any way. Instead, the present disclosure is directed toward all novel and nonobvious features and aspects of the various disclosed embodiments, alone and in various combinations and subcombinations with one another. The disclosed methods, apparatuses, and systems are not limited to any specific aspect or feature or combination thereof, nor do the disclosed embodiments require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

Although the operations of some of the disclosed methods are described in a particular, sequential order for convenient presentation, it is to be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

The following examples pertain to additional embodiments of technologies disclosed herein.

Example A1 includes an apparatus comprising: a substrate; and a multi-die layered structure including a first primary integrated circuit die communicatively coupled to a first photonic integrated circuit (PIC) die and conductively coupled to the substrate, and a second primary integrated circuit die attached to the first primary integrated circuit die and communicatively coupled to a second PIC die. The apparatus of Example A1 further includes a first intermediate waveguide optically coupling the first PIC die to a first substrate waveguide in the substrate and a second intermediate waveguide optically coupling the second PIC die to a second substrate waveguide in the substrate.

Example A2 comprises the subject matter of Example A1, and the substrate includes a first substrate waveguide array.

Example A3 comprises the subject matter of Example A2, and a third intermediate waveguide optically coupling the first PIC die to the second PIC die, and the first substrate waveguide array further includes the second substrate waveguide.

Example A4 comprises the subject matter of any one of Examples A2-A3, and the second PIC die is substantially horizontally aligned with the first primary integrated circuit die.

Example A5 comprises the subject matter of Example A4, and a lower surface of the second PIC die is bonded to an upper surface of the first PIC die.

Example A6 comprises the subject matter of any one of Examples A4-A5, and the first substrate waveguide array is disposed in a substrate upper surface of the substrate and is horizontally spaced outwardly from a first plane aligned with a first outer edge of the first PIC die.

Example A7 comprises the subject matter of Example A6, and a second substrate waveguide array including the second substrate waveguide and disposed in the substrate upper surface, and the second substrate waveguide array is horizontally spaced outwardly from a second plane aligned with a second outer edge of the second PIC die, and the multi-die layered structure is disposed in a space defined between the first plane and the second plane.

Example A8 comprises the subject matter of Example A7, and the first primary integrated circuit die is communicatively coupled to the first PIC die by a first electrical integrated circuit (EIC), and the second primary integrated circuit die is communicatively coupled to the second PIC die by a second EIC.

Example A9 comprises the subject matter of Example A8, and the first EIC is integrated with the first primary integrated circuit die and the second EIC is integrated with the second primary integrated circuit die, and the first EIC is disposed toward the first plane and the second EIC is disposed toward the second plane.

Example A10 comprises the subject matter of Example A8, and the first EIC is horizontally aligned with and separate from the first primary integrated circuit die and the second EIC is horizontally aligned with and separate from the second primary integrated circuit die.

Example A11 comprises the subject matter of Example A8, and the first EIC is integrated with the first PIC die and the second EIC is integrated with the second PIC die.

Example A12 comprises the subject matter of any one of Examples A1-A11, and the multi-die layered structure is one of a plurality of multi-die layered structures conductively coupled to the substrate.

Example A13 comprises the subject matter of any one of Examples A1-A12, and the first intermediate waveguide and the second intermediate waveguide are photonic waveguide bonds (PWBs).

Example A14 comprises the subject matter of any one of Examples A1-A12, and the first PIC die includes a first micro-lens array coupled to a second micro-lens array in an optical coupler containing the first intermediate waveguide, and one end of the first intermediate waveguide terminates at a first micro-lens in the second micro-lens array.

Example A15 comprises the subject matter of Example A14, and the optical coupler further comprises a third micro-lens array optically coupled to a fourth micro-lens array in the substrate, and an opposite end of the first intermediate waveguide terminates at a second microlens in the third micro-lens array.

Example A16 comprises the subject matter of any one of Examples A1-A12, and the first intermediate waveguide is disposed in an optical coupler comprising glass.

Example A17 comprises the subject matter of any one of Examples A1-A16 and S1-S16 and the first primary integrated circuit die includes one of a first processing unit, a first memory, a first memory controller, a first input/output controller, or a first network interface controller, and the second primary integrated circuit die includes one of a second processing unit, a second memory, a second memory controller, a second input/output controller, or a second network interface controller

Example S1 includes a system comprising: a board; and an integrated circuit component attached to the board. The integrated circuit component of Example S1 comprises a substrate including a first substrate waveguide, a multi-die layered structure conductively coupled to the substrate, the multi-die layered structure including a first primary integrated circuit die communicatively coupled to a first photonic integrated circuit (PIC) die, a first intermediate waveguide optically coupling the first PIC die to the first substrate waveguide, and one or more other intermediate waveguides optically coupling the first PIC die to one or more other PIC dies attached to one or more other primary integrated circuit dies respectively, in the multi-die layered structure.

Example S2 comprises the subject matter of Example S1, and the multi-die layered structure further comprises a second primary integrated circuit die communicatively coupled to a second PIC die and a second intermediate waveguide optically coupling the second PIC die to a second substrate waveguide in the substrate.

Example S3 comprises the subject matter of Example S2, and the second PIC die is substantially horizontally aligned with the first primary integrated circuit die.

Example S4 comprises the subject matter of any one of Examples S2-S3, and a lower surface of the second PIC die is bonded to an upper surface of the first PIC die, and the first PIC die is received within a recess formed in an upper surface of the substrate.

Example S5 comprises the subject matter of Example S4, and the first primary integrated circuit die is communicatively coupled to the first PIC die by a first electrical integrated circuit (EIC), and the second primary integrated circuit die is communicatively coupled to the second PIC die by a second EIC.

Example S6 comprises the subject matter of any one of Examples S4-S5, and a first planar boundary aligned with a first outer edge of the first PIC die and a second planar boundary aligned with a second outer edge of the second PIC die define a space therebetween in which the multi-die layered structure is disposed.

Example S7 comprises the subject matter of Example S6, and the first EIC is spaced from the first planar boundary and the second EIC is spaced from the second planar boundary.

Example S8 comprises the subject matter of Example S7, and the first substrate waveguide is disposed in an upper surface of the substrate and spaced outwardly from the first planar boundary and the second substrate waveguide is disposed in the upper surface of the substrate and spaced outwardly from the second planar boundary.

Example S9 comprises the subject matter of Example S8, and the first EIC is integrated with the first primary integrated circuit die and the second EIC is integrated with the second primary integrated circuit die.

Example S10 comprises the subject matter of Example S8, and the first EIC is horizontally aligned with and separate from the first primary integrated circuit die and the second EIC is horizontally aligned with and separate from the second primary integrated circuit die.

Example S11 comprises the subject matter of Example S8, and the first EIC is integrated with the first PIC die and the second EIC is integrated with the second PIC die.

Example S12 comprises the subject matter of any one of Examples S1-S11, and the multi-die layered structure is one of a plurality of multi-die layered structures conductively coupled to the substrate.

Example S13 comprises the subject matter of any one of Examples S1-S12, and the first intermediate waveguide and the one or more other intermediate waveguides are photonic waveguide bonds (PWBs).

Example S14 comprises the subject matter of any one of Examples S1-S12, and the first PIC die includes a first micro-lens array coupled to a second micro-lens array in an optical coupler, the optical coupler containing the first intermediate waveguide, and one end of the first intermediate waveguide terminates at a first microlens in the second micro-lens array.

Example S15 comprises the subject matter of Example S14, and the optical coupler further comprises a third micro-lens array optically coupled to a fourth micro-lens array in the substrate, and an opposite end of the first intermediate waveguide terminates at a second microlens in the third micro-lens array.

Example S16 comprises the subject matter of any one of Examples S1-S12, and the first intermediate waveguide is disposed in an optical coupler comprising glass.

Example S17 comprises the subject matter of any one of Examples S1-S16, and the first primary integrated circuit die includes one of a first processing unit, a first memory, a first memory controller, a first input/output controller, or a first network interface controller.

Example D1 includes an apparatus comprising: a substrate; and a structure conductively coupled to the substrate, the structure including a first interlocking layer including a first processing unit and a first photonic integrated circuit (PIC) die, a second interlocking layer including a second processing unit and a second PIC die, and the second interlocking layer is attached to an upper side of the first interlocking layer, a first intermediate waveguide optically coupling the first PIC die to the substrate, and a second intermediate waveguide optically coupling the second PIC die to the substrate.

Example D2 comprises the subject matter of Example D1, and the substrate includes a first substrate waveguide coupled to a first end of the first intermediate waveguide and a second substrate waveguide coupled to a second end of the second intermediate waveguide.

Example D3 comprises the subject matter of Example D2, and the first PIC die includes a first PIC waveguide coupled to a third end of the first intermediate waveguide, and the second PIC die includes a second PIC waveguide coupled to a fourth end of the first intermediate waveguide.

Example D4 comprises the subject matter of any one of Examples D2-D3, and the first substrate waveguide and the second substrate waveguide are disposed in an upper surface of the substrate on opposite sides of the structure.

Example D5 comprises the subject matter of any one of Examples D1-D4, and the first processing unit is communicatively coupled to the first PIC die by a first electrical integrated circuit (EIC), and the second processing unit is communicatively coupled to the second PIC die by a second EIC.

Example D6 comprises the subject matter of Example D5, and the first EIC is horizontally aligned with and separate from the first processing unit and the second EIC is horizontally aligned with and separate from the second processing unit.

Example D7 comprises the subject matter of Example D5, and the first EIC is integrated with the first PIC die and the second EIC is integrated with the second PIC die.

Example D8 comprises the subject matter of any one of Examples D1-D7, and the structure further includes a third intermediate waveguide optically coupling the first PIC die to the second PIC die.

Example D9 comprises the subject matter of any one of Examples D1-D8, and the second PIC die is substantially horizontally aligned with the first processing unit.

Example D10 comprises the subject matter of any one of Examples D1-D9, and a lower surface of the second PIC die is bonded to an upper surface of the first PIC die.

Example D11 comprises the subject matter of any one of Examples D1-D10, and the structure is one of a plurality of structures conductively coupled to the substrate.

Example D12 comprises the subject matter of any one of Examples D1-D11, and the first intermediate waveguide and the second intermediate waveguide are photonic waveguide bonds (PWBs).

Example D13 comprises the subject matter of any one of Examples D1-D11, and the first PIC die includes a first micro-lens array coupled to a second micro-lens array in an optical coupler containing the first intermediate waveguide, and one end of the first intermediate waveguide terminates at a first microlens in the second micro-lens array.

Example D14 comprises the subject matter of Example D13, and the optical coupler further comprises a third micro-lens array optically coupled to a fourth micro-lens array in the substrate, and an opposite end of the first intermediate waveguide terminates at a second microlens in the third micro-lens array.

Example D15 comprises the subject matter of any one of Examples D1-D11, and the first intermediate waveguide is disposed in an optical coupler comprising glass.

Example W1 comprises the subject matter of any one of Examples A1-A17, S1-S17, or D1-D15 and the substrate comprises a solid layer of glass rectangular in shape in a plan view.

Example W2 comprises the subject matter of any one of Examples A1-A17, S1-S17, or D1-D15, and the substrate comprises (i) a layer of glass comprising Silicon, Oxygen, and Aluminum; or (ii) the layer of glass comprising at least 23 percent Silicon and at least 26 percent Oxygen by weight, and further comprising at least 5 percent Aluminum by weight.

Example W3 comprises the subject matter of any one of Examples A1-A17, S1-S17, or D1-D15, and the substrate comprises a layer of glass that does not include an organic adhesive or an organic material.

Example W4 includes the subject matter of any one of Examples A17, S17, D1-D15, or W1-W3, and further comprises a processing unit conductively coupled to the first processing unit.

Example W5 includes the subject matter of any one of Examples A1-A17, S1-S17, D1-D15, or W1-W4, and the first PIC and the second PIC comprises a light source.

Example W6 includes the subject matter of any one of Examples A1-A17, S1-S17, D1-D15, or W1-W4, and the first PIC and the second PIC comprises a laser.

Example W7 includes the subject matter of any one of Examples A1-A17, S1-S17, D1-D15, or W1-W4, and the PIC comprises a photodetector.

Example W8 includes the subject matter of any one of Examples A1-A17, S1-S17, D1-D15, or W1-W7 and further comprises a socket, the substrate attached to the socket, the socket attached to a printed circuit board.

Example W9 includes the subject matter of Example W8, further including a memory integrated circuit component attached to the printed circuit board.

Example W10 includes the subject matter of any one of Examples A1-A17, S1-S17, D1-D15, or W1-W9, and the processing unit, the first PIC, the second PIC, and the first intermediate waveguide are enclosed in a housing of a computing system.

Example W11 includes the subject matter of any one of Examples A1-A17, S2-S12, or D1-D15, and the processing unit, the first PIC, the second PIC, and the first intermediate waveguide, and the second intermediate waveguide are enclosed in a housing of a computing system.

Example M1 provides a method comprising: forming a cutout in a substrate of an integrated circuit component, attaching a first photonic integrated circuit (PIC) die to the substrate, attaching a first primary integrated circuit die to the substrate and to the first PIC die to for a first interlocking layer, assembling a second interlocking layer including a second integrated circuit die and a second PIC die, attaching the second interlocking layer to the first interlocking layer, connecting the first PIC die to a first substrate waveguide in the substrate using a first intermediate waveguide, and connecting the second PIC die to a second substrate waveguide in the substrate using a second intermediate waveguide.

Example M2 comprises the subject matter of Example M1, and connecting the second PIC die to the first PIC die using a third intermediate waveguide.

Example M3 comprises the subject matter of M2, and the first intermediate waveguide, the second intermediate waveguide, and the third intermediate waveguide are photonic waveguide bonds (PWBs).

Example M4 comprises the subject matter of M2, and the first intermediate waveguide, the second intermediate waveguide, and the third intermediate waveguide are formed in an optical coupler including a first micro-lens array to be connected to a second micro-lens array on the first PIC die.

Example M5 comprises the subject matter of any one of Examples M1-M2, and the connecting the first intermediate waveguide to the first substrate waveguide and connecting the second intermediate waveguide to the second substrate waveguide includes connecting the first micro-lens array of the optical coupler to a second micro-lens array of the first PIC die, wherein the first intermediate waveguide and the second intermediate waveguide have first ends terminating at the first micro-lens array.

Example M6 comprises the subject matter of any one of Examples M1-M2, and the connecting the first intermediate waveguide to the first substrate waveguide and connecting the second intermediate waveguide to the second substrate waveguide further includes connecting a third micro-lens array of the optical coupler to a fourth micro-lens array of the substrate, wherein the first intermediate waveguide and the second intermediate waveguide have second ends terminating at the third micro-lens array.

Example M7 comprises the subject matter of any one of Examples M1-M6, and the assembling the second interlocking layer includes attaching a second primary integrated circuit die to the second PIC die such that a front portion of a lower surface of the second primary integrated circuit die opposes a back portion of an upper surface of the second PIC die.

Example M8 comprises the subject matter of any one of Examples M1-M7, and further comprises applying an adhesive to an upper surface of the first PIC die, and the attaching the second interlocking layer to the first interlocking layer includes bonding the first PIC die to the second PIC die with the adhesive disposed between a lower surface of the second PIC die and an upper surface of the first PIC die.

Example M9 comprises the subject matter of any one of Examples M1-M8, and the attaching the second interlocking layer to the first interlocking layer includes connecting the first primary integrated circuit die to the second primary integrated circuit die with conductive contacts on an upper surface of the first primary integrated circuit die and a lower surface of the second primary integrated circuit die.

1. An apparatus comprising:
a substrate;
a multi-die layered structure including:
a first primary integrated circuit die communicatively coupled to a first photonic integrated circuit (PIC) die and conductively coupled to the substrate; and
a second primary integrated circuit die attached to the first primary integrated circuit die and communicatively coupled to a second PIC die;
a first intermediate waveguide optically coupling the first PIC die to a first substrate waveguide in the substrate; and
a second intermediate waveguide optically coupling the second PIC die to a second substrate waveguide in the substrate.

2. The apparatus of claim 1, wherein the substrate includes a first substrate waveguide array.

3. The apparatus of claim 2, further comprising:
a third intermediate waveguide optically coupling the first PIC die to the second PIC die, wherein the first substrate waveguide array further includes the second substrate waveguide.

4. The apparatus of claim 2, wherein the second PIC die is substantially horizontally aligned with the first primary integrated circuit die.

5. The apparatus of claim 4, wherein the first substrate waveguide array is disposed in a substrate upper surface of the substrate and is horizontally spaced outwardly from a first plane aligned with a first outer edge of the first PIC die.

6. The apparatus of claim 5, further comprising:
a second substrate waveguide array including the second substrate waveguide and disposed in the substrate upper surface, wherein the second substrate waveguide array is horizontally spaced outwardly from a second plane aligned with a second outer edge of the second PIC die, wherein the multi-die layered structure is disposed in a space defined between the first plane and the second plane.

7. The apparatus of claim 6, wherein the first primary integrated circuit die is communicatively coupled to the first PIC die by a first electrical integrated circuit (EIC), wherein the second primary integrated circuit die is communicatively coupled to the second PIC die by a second EIC.

8. The apparatus of claim 7, wherein the first EIC is integrated with the first primary integrated circuit die and the second EIC is integrated with the second primary integrated circuit die, wherein the first EIC is disposed toward the first plane and the second EIC is disposed toward the second plane.

9. The apparatus of claim 7, wherein the first EIC is horizontally aligned with and separate from the first primary integrated circuit die and the second EIC is horizontally aligned with and separate from the second primary integrated circuit die.

10. The apparatus of claim 7, wherein the first EIC is integrated with the first PIC die and the second EIC is integrated with the second PIC die.

11. The apparatus of claim 1, wherein the first intermediate waveguide and the second intermediate waveguide are photonic waveguide bonds (PWBs).

12. The apparatus of claim 1, wherein the first intermediate waveguide and the second intermediate waveguide are disposed in an optical coupler, the optical coupler including a second micro-lens array optically coupled to a first micro-lens array in the first PIC die.

13. The apparatus of claim 1, wherein the substrate comprises a solid layer of glass rectangular in shape in a plan view.

14. The apparatus of claim 1, wherein the substrate comprises (i) a layer of glass comprising Silicon, Oxygen, and Aluminum; or (ii) the layer of glass comprising at least 23 percent Silicon and at least 26 percent Oxygen by weight, and further comprising at least 5 percent Aluminum by weight.

15. The apparatus of claim 1, wherein the substrate comprises a layer of glass that does not include an organic adhesive or an organic material.

16. A system comprising:
a board; and
an integrated circuit component attached to the board, the integrated circuit component comprising:
a substrate including a first substrate waveguide;
a multi-die layered structure conductively coupled to the substrate, the multi-die layered structure including a first primary integrated circuit die communicatively coupled to a first photonic integrated circuit (PIC) die;
a first intermediate waveguide optically coupling the first PIC die to the first substrate waveguide; and
one or more other intermediate waveguides optically coupling the first PIC die to one or more other PIC dies attached to one or more other primary integrated circuit dies respectively, in the multi-die layered structure.

17. The system of claim 16, wherein the first intermediate waveguide and the one or more other intermediate waveguides are photonic waveguide bonds (PWBs).

18. The system of claim 16, wherein the first intermediate waveguide and the one or more other intermediate waveguides are disposed in an optical coupler, the optical coupler including a second micro-lens array optically coupled to a first micro-lens array in the first PIC die.

19. An apparatus comprising:
a substrate; and
a structure conductively coupled to the substrate, the structure including:
a first interlocking layer including a first processing unit and a first photonic integrated circuit (PIC) die;
a second interlocking layer including a second processing unit and a second PIC die, wherein the second interlocking layer is attached to an upper side of the first interlocking layer;
a first intermediate waveguide optically coupling the first PIC die to the substrate; and
a second intermediate waveguide optically coupling the second PIC die to the substrate.

20. The apparatus of claim 19, wherein the structure further includes a third intermediate waveguide optically coupling the first PIC die to the second PIC die.
